(19) United States
(12) Patent Application Publication
(10) Pub. No.: US 2018/0027218 A1
(43) Pub. Date: Jan. 25, 2018

(54) WORK ASSISTANCE DEVICE, WORK ASSISTANCE SYSTEM, WORK ASSISTANCE METHOD, AND RECORDING MEDIUM STORING WORK ASSISTANCE PROGRAM

(71) Applicant: NEC Corporation, Tokyo (JP)

(72) Inventors: Hiroaki KISO, Tokyo (JP); Kan ARAI, Tokyo (JP); Nobuyuki YASUKAWA, Tokyo (JP)

(73) Assignee: NEC Corporation, Tokyo (JP)

(21) Appl. No.: 15/550,254

(22) PCT Filed: Feb. 15, 2016
(86) PCT No.: PCT/JP2016/000777

§ 371 Date: Aug. 10, 2017

(30) Foreign Application Priority Data
Feb. 16, 2015 (JP) 2015-027785

(51) Int. Cl. H04N 9/31; G05B 19/042; G06Q 10/06

(52) U.S. Cl. CPC H04N 9/3179; G06Q 10/063112; G05B 19/042; G05B 2219/37074

(57) ABSTRACT

Provided is a work assistance device that enables the working time of a worker to be reduced in a reliable manner. A work assistance device according to one embodiment of the present invention is equipped with: a reading means and a projection control means. The reading means sequentially reads from a work storage means, in accordance with the order of the steps of work performed by a worker, a projection data set for each of the steps. The work storage means stores a work procedure wherein the projection data set is associated with the order of the steps, said projection data set including an indication display that includes a visually recognizable visual representation which indicates, for each of the steps, a location where the work for that step is performed and a member to be handled in the work for that step. In response to the reading of the projection data set the projection control means uses a projection means to project the indication display included in the projection data set, said indication display being projected during an indication display projection time, which is a projection time that has been determined for that indication display.

### TECHNICAL FIELD

The present invention relates to a technology of assisting work of a worker.

### BACKGROUND ART

Technologies of assisting work of mounting a part on a printed wiring board and the like are disclosed, for example, in PTL 1 to PTL 4.

PTL 1 describes a projector mounting machine projecting, by light, a position where an electronic part is equipped on a printed wiring board and which is recorded on an endless film. When a button switch is pressed down, the projector mounting machine moves the endless film by one frame. A position where an electronic part is equipped in a next process is recorded on a next frame in the endless film. When the endless film moves by one frame, the position where the electronic part is equipped in the next process is projected on the printed wiring board.

PTL 2 describes an electronic parts manual mounting machine supplying a taped electronic part. The electronic parts manual mounting machine changes an angle at which an electronic part is supplied, according to a direction in which the electronic part is mounted on a mounting substrate. When a supplied part is taken out, the electronic parts manual mounting machine supplies a next part.

PTL 3 describes a work assistance device projecting a character, an image, and the like by a projector on a screen of a parts storage box from which a part used in a present process is taken out, out of a plurality of parts storage boxes in front of which screens are installed. The work assistance device detects takeout of a part by detecting light shielding at a location of a parts storage box by an area sensor. When light shielding at the location of the parts storage box is detected, the work assistance device displays a character, an image, and the like that are related to assembly work in a present process on a monitor. When a worker completing the assembly work turns on a work confirmation switch, the work assistance device performs processing related to a next process.

PTL 4 describes a part mounting method of projecting light on a location where a part is mounted on a printed wiring board, by using a projector and a mask that has a hole at a location related to a position of the mounted part. In the part mounting method, a part is mounted at a location where light is projected. A worker mounts each part, for example, by taking off one by one a plurality of masks prepared for each part.

PTL 5 describes an assembly device that performs mounting an electronic part on a printed wiring board, and the like. When an anomaly occurs, the assembly device reports the anomaly to a worker by producing, by an alarm buzzer, a sound based on a registered sound registered in a storage device.

### CITATION LIST

### Patent Literature

[PTL 1] Japanese Examined Utility Model Application Publication No. S60-035257

[PTL 2] Japanese Unexamined Patent Application Publication No. 2010-238718

[PTL 3] Japanese Unexamined Patent Application Publication No. 2008-222386

[PTL 4] Japanese Unexamined Patent Application Publication No. S58-031596

[PTL 5] Japanese Unexamined Patent Application Publication No. H05-198980

### SUMMARY OF INVENTION

### Technical Problem

In the technologies described in PTL 1 to PTL 4, when a worker completes work in a process, processing that assists work in a next process is performed. In the technologies described in PTL 1 to PTL 4, working hours are determined by a worker. When a worker works slowly, working hours are extended. Accordingly, the technologies described in PTL 1 to PTL 4 may not necessarily reduce working hours by a worker stably.

In the assembly device in PTL 5, a worker is able to identify an assembly line in which an anomaly occurs, for example, by registering a different registered sound for each assembly line in a storage device. However, the technology in PTL 5 is not able to reduce time required for a worker to perform work such as mounting a part.

An object of the present invention is to provide a work assistance device that is able to stably reduce working hours by a worker.

### Solution to Problem

A work assistance device according to an aspect of the present invention includes: reading means for sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and projection control means for projecting, by projection means, the indication display included in the projection data set, upon readout of the projection data set, for a period of an indication display projection time being a projection time determined for the indication display.

A work assistance method according to an aspect of the present invention includes: sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and projecting, by projection means, the indication display included in the projection data set, upon readout of the projection data set, for a period of an indication display projection time being a projection time determined for the indication display.

A storage medium according to an aspect of the present invention stores a work assistance program causing a computer to perform: reading processing of sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and projection control processing of projecting, by projection means, the indication display included in the projection data set, upon readout of the projection data set, for a period of an indication display projection time being a projection time determined for the indication display. The present invention may also be provided by the work assistance program stored in the recording medium described above.

### Advantageous Effects of Invention

The present invention provides an effect of stably reducing working hours by a worker.

### BRIEF DESCRIPTION OF DRAWINGS

FIG. 1 is a block diagram illustrating a configuration example of a work assistance device according to a first example embodiment of the present invention.

FIG. 2 is a diagram illustrating an example of buttons included in a specially designed input unit in the work assistance device according to the first example embodiment of the present invention.

FIG. 3 is a diagram illustrating an example of buttons included in a specially designed input unit in the work assistance device according to the first example embodiment of the present invention.

FIG. 4 is a diagram schematically illustrating an example of the work assistance device and a work environment, according to the first example embodiment of the present invention.

FIG. 5 is a flowchart illustrating an example of an entire operation of projecting a work indication by the work assistance device according to the first example embodiment of the present invention.

FIG. 6 is a diagram illustrating an example of a skill level of a worker stored in a skill level storage unit in the work assistance device according to the first example embodiment of the present invention.

FIG. 7 is a diagram illustrating a first example of a multiplying factor stored in the skill level storage unit in the work assistance device according to the first example embodiment of the present invention.

FIG. 8 is a diagram schematically illustrating a first example of a work procedure stored in a work storage unit in the work assistance device according to the first example embodiment of the present invention.

FIG. 9 is a flowchart illustrating a first example of an operation of work indication projection processing in the work assistance device according to the first example embodiment of the present invention.

FIG. 10 is a flowchart illustrating the first example of the operation of the work indication projection processing in the work assistance device according to the first example embodiment of the present invention.

FIG. 11 is a diagram illustrating a second example of a multiplying factor stored in the skill level storage unit in the work assistance device according to the first example embodiment of the present invention.

FIG. 12 is a diagram schematically illustrating a second example of a work procedure stored in the work storage unit in the work assistance device according to the first example embodiment of the present invention.

FIG. 13 is a diagram schematically illustrating a third example of a work procedure stored in the work storage unit in the work assistance device according to the first example embodiment of the present invention.

FIG. 14 is a diagram illustrating a first example of a visual representation represented by an animation in the work assistance device according to the first example embodiment of the present invention.

FIG. 15 is a diagram illustrating a second example of a visual representation represented by an animation in the work assistance device according to the first example embodiment of the present invention.

FIG. 16 is a flowchart illustrating an operation example of the work assistance device according to the first example embodiment of the present invention when a control instruction is input by a worker.

FIG. 17 is a diagram schematically illustrating an example of a history stored in a history storage unit in the work assistance device according to the first example embodiment of the present invention.

FIG. 18 is a diagram schematically illustrating an example of an indication display and the like projected by a projection control unit in the work assistance device according to the first example embodiment of the present invention.

FIG. 19 is a diagram schematically illustrating an example of an indication display and the like projected by the projection control unit in the work assistance device according to the first example embodiment of the present invention.

FIG. 20 is a diagram schematically illustrating an example of an indication display and the like projected by the projection control unit in the work assistance device according to the first example embodiment of the present invention.

FIG. 21 is a diagram schematically illustrating an example of an indication display and the like projected by the projection control unit in the work assistance device according to the first example embodiment of the present invention.

FIG. 22 is a diagram schematically illustrating an example of an indication display and the like projected by the projection control unit in the work assistance device according to the first example embodiment of the present invention.

FIG. 23 is a diagram schematically illustrating an example of an indication display and the like projected by the projection control unit in the work assistance device according to the first example embodiment of the present invention.

FIG. 24 is a diagram schematically illustrating an example of an indication display and the like projected by the projection control unit in the work assistance device according to the first example embodiment of the present invention.

FIG. 25 is a diagram schematically illustrating an example of an indication display and the like projected by the projection control unit in the work assistance device according to the first example embodiment of the present invention.

FIG. 26 is a diagram schematically illustrating an example of an indication display and the like projected by the projection control unit in the work assistance device according to the first example embodiment of the present invention.

FIG. 27 is a diagram schematically illustrating an example of an indication display and the like projected by the projection control unit in the work assistance device according to the first example embodiment of the present invention.

FIG. 28 is a diagram schematically illustrating an example of an indication display and the like projected by the projection control unit in the work assistance device according to the first example embodiment of the present invention.

FIG. 29 is a diagram schematically illustrating an example of an indication display and the like projected by the projection control unit in the work assistance device according to the first example embodiment of the present invention.

FIG. 30 is a diagram schematically illustrating an example of an indication display and the like projected by the projection control unit in the work assistance device according to the first example embodiment of the present invention.

FIG. 31 is a diagram schematically illustrating an example of an indication display and the like projected by the projection control unit in the work assistance device according to the first example embodiment of the present invention.

FIG. 32 is a diagram schematically illustrating an example of an indication display and the like projected by the projection control unit in the work assistance device according to the first example embodiment of the present invention.

FIG. 33 is a diagram schematically illustrating an example of an indication display and the like projected by the projection control unit in the work assistance device according to the first example embodiment of the present invention.

FIG. 34 is a diagram schematically illustrating an example of an indication display and the like projected by the projection control unit in the work assistance device according to the first example embodiment of the present invention.

FIG. 35 is a diagram schematically illustrating an example of an indication display and the like projected by the projection control unit in the work assistance device according to the first example embodiment of the present invention.

FIG. 36 is a block diagram illustrating a configuration example of a work assistance device according to a second example embodiment of the present invention.

FIG. 37 is a diagram illustrating a hardware configuration example of a computer with which the work assistance devices according to the respective embodiments of the present invention are able to be achieved.

FIG. 38 is a flowchart illustrating an operation example of the work assistance device according to the second example embodiment of the present invention.

FIG. 39 is a block diagram illustrating a configuration example of the work assistance device according to the first example embodiment of the present invention, being achieved with a circuit.

FIG. 40 is a block diagram illustrating a configuration example of the work assistance device according to the second example embodiment of the present invention, being achieved with a circuit.

### DESCRIPTION OF EMBODIMENTS

Next, referring to the drawings, example embodiments of the present invention will be described in detail.

### First Example Embodiment

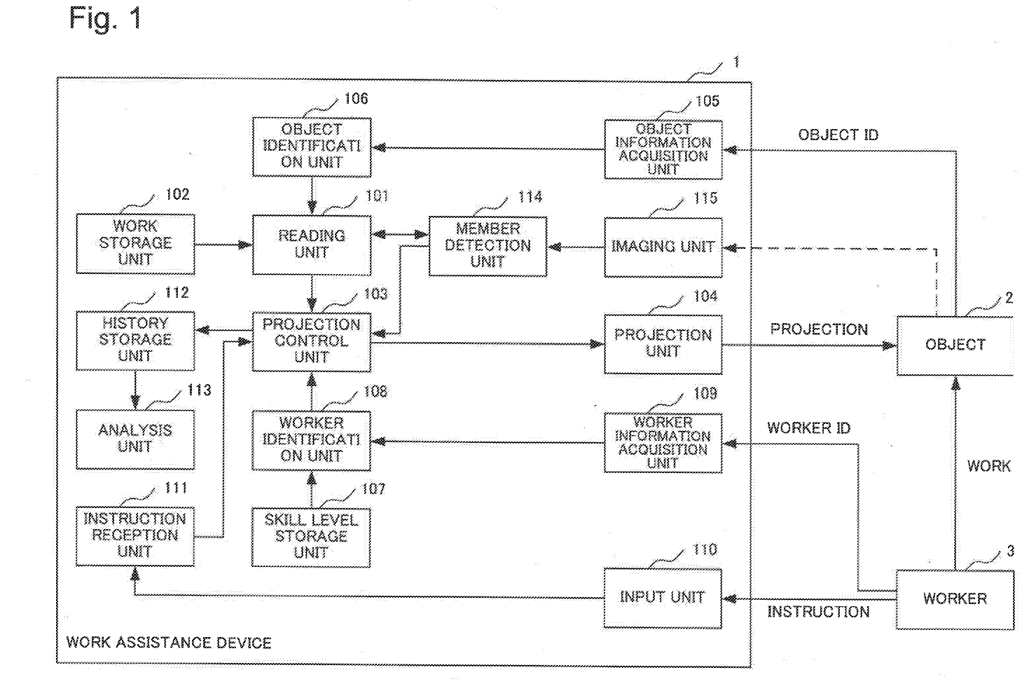

FIG. 1 is a block diagram illustrating a configuration example of a work assistance device 1 according to a first example embodiment of the present invention.

Referring to FIG. 1, the work assistance device 1 according to the present example embodiment includes a reading unit 101, a work storage unit 102, a projection control unit 103, and a projection unit 104. The work assistance device 1 according to the present example embodiment may further include an object information acquisition unit 105, an object identification unit 106, a skill level storage unit 107, a worker identification unit 108, a worker information acquisition unit 109, a member detection unit 114, and an imaging unit 115. The work assistance device 1 according to the present example embodiment may further include an input unit 110, an instruction reception unit 111, a history storage unit 112, and an analysis unit 113. In the example illustrated in FIG. 1, the work assistance device 1 includes each of the units listed above.

The projection unit 104, the object information acquisition unit 105, the worker information acquisition unit 109, the input unit 110, and the imaging unit 115 may be achieved as a device that includes one or more of the units, is separated from the work assistance device 1, and is communicably connected to the work assistance device 1. The projection unit 104 is achieved, for example, as a projector that receives a video signal from the work assistance device 1 and projects a video image represented by the received video signal. The video image indicates, for example, a moving image represented by sequential static images (i.e. frames). The analysis unit 113 may be achieved as another device that is communicably connected to the work assistance device 1 and is able to access the history storage unit 112.

As will be described in detail below, the projection control unit 103 according to the present example embodiment projects, by the projection unit 104, an indication display indicating work to be performed on an object of the work (i.e. an object 2) by a worker for each process, and the like. When work performed by a worker is work of mounting a part on a substrate, the substrate is the object of the work. For example, in a process in which a worker takes out a part, the projection control unit 103 projects an indication display indicating a part to be taken out and a location where the part to be taken out is stored on the location where the part is stored. In a process in which a worker takes out an object 2 such as a part, the projection control unit 103 does not necessarily need to project an indication display on a location where the member is stored. For example, in a process in which a worker takes out a member such as a part, the projection control unit 103 may project, on a vicinity of the location where the member is stored, an indication display indicating a member to be taken out and a location where the member to be taken out is stored. For example, in a process in which a worker mounts a part on a substrate, the projection control unit 103 projects, on the location where the part is mounted, an indication display indicating a part to be mounted and a location where the part is mounted. For example, in a process in which a worker mounts a part on a substrate, when a caution in the work of mounting a part exists, the projection control unit 103 projects a caution display indicating the caution on the substrate. Lengths of time for which the projection control unit 103 projects an indication display, a caution display, and the like are determined independently of whether or not a worker completes work in each process.

Next, each component of the work assistance device 1 will be described in detail.

The work storage unit 102 stores a work procedure in which a projection data set is associated with a sequence number of a process, and the projection data set includes an indication display indicating, for each process of work performed by a worker, a position where work is performed and a member handled in the work. The projection data set may further include a caution display indicating a caution in work in a process that requires attention. The projection data set may further include an indication display projection time that is a length of a projection time for which an indication display is projected. The projection data set may further include a caution display projection time that is a length of a projection time for which a caution display is projected.

As will be described later, any of an indication display, a caution display, and a guidance display may be a display represented by an animation. Additionally, any of the indication display, the caution display, and the guidance display may be a combination of a display represented by an animation lasting for a predetermined period of time from a start of the display, and a subsequent display represented by a static image and the like. In that case, the projection data set may further include an indication display effective time that is a time for which an indication display is represented by an animation. The indication display effective time may be a ratio to an indication display projection time. The projection data set may further include a caution display effective time that is a time for which a caution display is represented by an animation. The caution display effective time may be a ratio to a caution display projection time. The projection data set may further include a guidance display effective time that is a time for which a guidance display is represented by an animation. The guidance display effective time may be a ratio to a guidance display projection time.

The projection data set may further include a guidance display indicating guidance from a location where work is performed in an immediately preceding process to a position where work, indicated by an indication display included in the projection data set, is performed. The work in the immediately preceding process is work of which the projection data set is associated with a sequence number immediately preceding the current sequence number. The projection data set may include a guidance display when a part handled in work in the immediately preceding process and a member indicated by an indication display included in the projection data set are identical members, otherwise may not include a guidance display.

The work storage unit 102 may store work procedures for a plurality of types of objects 2. When different finished products are created, for example, by processing a same type of object in different methods, a plurality of different work procedures exist for the same object. When a plurality of different work procedures exist as work procedures for a same type of object, the work storage unit 102 may store a work procedure for each of the plurality of work procedures. A work procedure stored in the work storage unit 102 may be assigned with a procedure identification (ID) identifying the work procedure. In the example embodiments of the present invention, an object ID, which is to be described later, is used as the procedure ID.

Work is, for example, work of mounting a part such as an electronic part on a substrate such as a printed wiring board. Work in that case includes, for example, takeout work that is work of taking out a part to be mounted on a substrate from a location (e.g. a parts box) where the part is stored, and mounting work that is work of mounting a taken-out part on a substrate. A location where the takeout work is performed is, for example, a location where a part is stored. A location where the mounting work is performed is, for example, a location where a part is mounted. A member handled in these types of work is a part.

In each of the example embodiments of the present invention, a process is a section of work for which an indication by displaying an indication display is provided. A process is, in a series of work with respect to an object 2, for example, at least part of the series of work in which a location where the work is performed is the same and a type of member handled in work is the same. The aforementioned series of work is, for example, work successively performed on the object 2 by one worker. The object 2 may be a single object or a combination of two or more objects. A series of work performed on a same object 2 at a same location may be appropriately divided into a plurality of processes.

When work is work of mounting a part on a substrate, work handled as one process in each of the example embodiments of the present invention is, for example, takeout work of taking out one or more parts from one location, mounting work of mounting one part on a substrate, and the like. A process of performing the mounting work, in the respective example embodiments of the present invention, is also referred to as a mounting process. A process of performing the takeout work is also referred to as a takeout process.

Work may further include, for example, application work that is work of applying a liquid such as an agent that improves a solder flow to a substrate. Work may include takeout work of taking out a container of the liquid from a location where the container is stored (also referred to as liquid takeout work), and storage work of storing a container at a location where the container is stored (also referred to as liquid storage work). A location where the application work is performed is, for example, a location where the liquid is applied. A location where the liquid takeout work is performed is, for example, a location where the container of the liquid is stored. A location where the liquid storage work is performed is a location where the container of the liquid is to be stored. A member handled in these types of work is the liquid. In this case, work that is handled as one process includes, for example, liquid takeout work of taking out a container of one liquid, application work of applying one type of liquid to one part, and liquid storage work of storing a container of a liquid. In a description of the present example embodiment and the like, a process in which the liquid takeout work is performed is referred to as a liquid takeout process or a takeout process. A process in which the application work is performed is referred to as an application process. A process in which the liquid storage work is performed is referred to as a liquid storage process or a storage process.

When a tool is required for mounting a part on a substrate, work may include takeout work that is work of taking out a tool from a location where the tool is stored (also referred to as tool takeout work) and storage work of storing a tool at a location where the tool is stored (also referred to as tool storage work). A position where the tool takeout work is performed is, for example, a position of a location where the tool is stored. A position where the tool storage work is performed is, for example, a position of a location where the tool is to be stored. In this case, work handled as one process includes, for example, tool takeout work of taking out a tool from one storage location and tool storage work of storing a tool at one storage location. A process of performing tool takeout work, in the present example embodiment and the like, is referred to as a tool takeout process or a takeout process. A process of performing work of storing a tool is referred to as a tool storage process or a storage process.

When a manipulation such as pressing a switch is performed on a device such as a tool and a machine in a process of work, the work may include manipulation work that is work of performing a manipulation on such a device. A location where the manipulation work is performed includes, for example, a location of a switch pressed in the manipulation work or a location where a device on which the manipulation work is performed is placed. A process of performing the manipulation work, in the present example embodiment and the like, is referred to as a manipulation process.

Work may include placement work that is work of placing an object 2 which is an object of the work at a predetermined location. In that case, a member handled in the work is the object 2. In this case, work handled as one process is, for example, work of placing the object 2 at one placement location. When the object 2 is a combination of a plurality of objects, work of placing the plurality of objects at their respective placement locations is considered as a plurality of different processes.

Without being limited to the examples above, work may include another type of work. Additionally, without being limited to the examples above, a process may include another type of process.

An indication display, a caution display, and a guidance display are visual representations indicating a location where work is performed and a member handled in the work, by a video image including the indication display which is projected on an object of the work and a location where the member is stored. The visual representation is, for example, a visually recognized representation such as an image, a character string, a moving image, an animation, or at least a partial combination thereof. An indication display, a caution display, and a guidance display are represented, for example, by an image, a character string, a dynamic image, an animation, or at least a partial combination thereof.

An indication display may be represented, for example, by a figure indicating a location where a part is mounted and a character string indicating the part. An indication display may be, for example, a figure indicating a location where a liquid is applied and a character string indicating the liquid. An indication display may be, for example, a figure indicating a location where a member such as a part, a liquid, or a tool is stored and a character string indicating the member. An indication display may be, for example, a figure indicating a location where a member such as a liquid or a tool is stored and a character string indicating the member. When work is placement work of placing an object 2 at a predetermined location, a figure representing an indication display may be a figure indicating a location where the object is placed. An indication display in that case includes, for example, a figure indicating a corner of the object 2, an outline of the object 2, or a figure indicating a corner or an outline of the object 2, and a pattern of the object.

A caution display may be represented by at least either of a character string or a figure indicating a caution. A caution display may be, for example, a character string plainly indicating a caution. A caution display may be, for example, a character string plainly indicating a caution and a figure enclosing the character string. A caution display may be, for example, a figure indicating a caution.

A guidance display may be, for example, a figure or the like indicating a direction or a move from a location where immediately preceding work is performed to a location where next work (i.e. current work) of that work is performed.

Data representing an indication display, data representing a caution display, and data representing a guidance display may be data representing a video image transmitted to the projection unit 104 as a video signal. In that case, a video image representing an indication display may be, for example, a video image adjusted so that a visual representation of the indication display is displayed at a location where work is performed or close to a location where work is performed, by the projection unit 104 projecting the video image. A video image representing a caution display may be, for example, a video image adjusted so that a visual representation of the caution display is displayed, by the projection unit 104 projecting the video image, at a location that is appropriately selected and can be readily and visually recognized by a worker. A video image representing a guidance display may be, for example, a video image adjusted so that a visual representation of the guidance display is displayed, by the projection unit 104 projecting the video image, between a location where immediately preceding work is performed and a location where next work of the work is performed. A guidance display may not be performed in any process. In the present example embodiment, a case that a guidance display is performed in a process in which a same member as that in an immediately preceding process is used will be described.

Indication display data representing an indication display, caution display data representing a caution display, and guidance display data representing a guidance display may be data including data representing a visual representation, and data indicating a position where the visual representation is superimposed on a video image transmitted to the projection unit 104. Data indicating a position where the visual representation is superimposed on a video image may be, for example, coordinates indicating a position in a two-dimensional image coordinate system, and the coordinates is set to the video image.

Data representing an indication display, data representing a caution display, and data representing a guidance display may be data including data representing a visual representation, and data indicating a position where the visual representation is projected by the projection unit 104. The data indicating a position where the visual representation is projected are, for example, coordinates indicating a position in a coordinate system set in a three-dimensional space. In that case, a relation between a coordinate system set in a three-dimensional space and an image coordinate system set to a video image may be known. In other words, transform from coordinates in the coordinate system set in a three-dimensional space to coordinates in the image coordinate system may be known. Then, for example, the projection control unit 103, to be described in detail later, may perform transform from coordinates indicating a position where the visual representation is projected in the coordinate system set in a three-dimensional space to coordinates indicating a position where the visual representation is superimposed on the video image in the image coordinate system.

In the description of each of the example embodiments of the present invention, an expression “a projection data set includes an indication display” means that the projection data set includes data representing the indication display. The same holds for a caution display, a guidance display, an indication display projection time, a caution display projection time, a guidance display projection time, and the like.

The object information acquisition unit 105 acquires data indicating an object ID that identifies a type of object 2 which is an object of work. The object information acquisition unit 105 transmits the acquired data indicating an object ID to the object identification unit 106. Different types of objects 2 may be assigned with different object IDs. Different object IDs may be assigned to the same type of objects 2 when types of work performed are different. The same object ID is assigned to the same combination of a type of object 2 and work, in each of the example embodiments of the present invention. An object ID is the aforementioned procedure ID. Specifically, the work storage unit 102 stores a work procedure assigned with an object ID as a procedure ID.

When an object 2 is a substrate, an object ID is an ID indicating a type of the substrate (hereinafter referred to as a substrate ID). An object 2 may be attached, for example, with a bar code indicating a type of the object 2. In that case, the object information acquisition unit 105 may be, for example, a bar code reader. Data indicating the object ID may take, for example, the form of a signal indicating a bar code read by the bar code reader. The bar code may be a two-dimensional bar code. The object information acquisition unit 105 may be, for example, a camera. In that case, the imaging unit 115, to be described in detail later, which is a camera capturing an image of an object may function as the object information acquisition unit 105. In this case, data indicating the object ID take the form of a captured image of the bar code.

The object information acquisition unit 105 may acquire a captured image of an entire object 2 or a characteristic part of the object 2 as data indicating an object ID.

An object 2 may be attached with a radio frequency identifier (RFID) in which an object ID is recorded. In that case, the object information acquisition unit 105 may be an RFID reader. Data indicating the object ID may take the form of a signal obtained by reading the RFID.

A worker 3 may input an object ID to the object information acquisition unit 105. In that case, the object information acquisition unit 105 may be achieved, for example, by a common input device such as a keyboard.

A worker 3 may input a list indicating a plurality of object IDs and order thereof to the object information acquisition unit 105 in advance. A plurality of object IDs and The list indicating the plurality of object IDs and the order thereof may be, for example, a list that is, for example, a text file in which the plurality of object IDs are arranged in order in which work in a work procedure indicated by the object ID is performed. The object information acquisition unit 105 stores the received list, for example, in an unillustrated storage unit. Then, when starting work or starting work related to a next object 2, the worker 3 may input an instruction (hereinafter referred to as a change instruction) to the object information acquisition unit 105, for example, by pressing a predetermined key on a keyboard. In response to the input of the change instruction, the object information acquisition unit 105 may acquire an object ID by reading an object ID with the earliest sequence number in unread object IDs from the list stored in the aforementioned storage unit.

The object identification unit 106 receives data indicating an object ID from the object information acquisition unit 105. Then, the object identification unit 106 identifies the object ID on the basis of the received data indicating the object ID. The object identification unit 106 transmits the identified object ID to the reading unit 101. For example, when data indicating an object ID take the form of a signal obtained by reading a bar code, the object identification unit 106 converts the signal into the object ID. When data indicating an object ID take the form of a captured image of a bar code, the object identification unit 106 converts the image into the object ID. When data indicating an object ID take the form of a signal obtained by reading an RFID, the object identification unit 106 converts the signal into the object ID.

When data indicating an object ID take the form of a captured image of an entire object 2 or a characteristic part of the object 2, the object identification unit 106 may identify a type of the object 2 on the basis of the received image by image matching. In that case, the object identification unit 106 may hold a captured image of a type of object 2 associated with the type of the object 2, for various types of objects 2. The object identification unit 106 may compare a received image with images held in advance of various types of objects 2. Then, the object identification unit 106 may identify an image most similar to the received image out of the images held in advance. The object identification unit 106 may determine a type of object 2 captured in the identified image to be the type of the object 2 captured in the received image. As a method of image matching by the object identification unit 106, a method such as template matching or comparison of feature values extracted from images, which is selected from various existing methods, is applicable.

When a plurality of types of work exist as work for an object 2 a type of which is identified by image matching, the work assistance device 1 may be configured to accept an input identifying a type of work, by the input unit 110. Then, a worker 3 may perform an input identifying a type of work, by the input unit 110. When the work assistance device 1 is configured to accept an input by the input unit 110, the input identifying a type of work, the instruction reception unit 111 and the object identification unit 106 may be communicably connected. The input unit 110 may transmit an input identifying a type of work, by the worker 3, to the object identification unit 106 through the instruction reception unit 111. In FIG. 1, a line indicating connection between the instruction reception unit 111 and the object identification unit 106 is omitted.

When data indicating an object ID take the form of a captured image of an entire object 2 or a characteristic part of the object 2, the object identification unit 106 may determine the object ID on the basis of an identified type of the object 2, or an identified type of the object 2 and an input by a worker 3.

The worker information acquisition unit 109 acquires data indicating a worker ID identifying a worker 3 performing work. The worker information acquisition unit 109 transmits the acquired data indicating the worker ID to the worker identification unit 108. For example, a worker may input a worker ID to the work assistance device 1 by using an input device such as a keyboard. In that case, the worker information acquisition unit 109 may be the input device. Then, data indicating a worker ID may take the form of a signal indicating the input by the worker. When the input unit 110, to be described later, is an input device capable of inputting a worker ID, the input unit 110 may function as the worker information acquisition unit 109.

The worker information acquisition unit 109 may be a card reader. In that case, a worker 3 causes the worker information acquisition unit 109 to read, for example, an ID card storing a worker ID. The worker information acquisition unit 109 reads the worker ID from the ID card. Data indicating a worker ID take the form of a signal obtained by reading an ID card.

The worker information acquisition unit 109 may be a sensor reading biometric information such as a face, a voice, an iris, a fingerprint, or a vein of a worker. In that case, data indicating a worker ID take the form of biometric information acquired by the worker information acquisition unit 109 that is a sensor. In this case, the worker identification unit 108 or the skill level storage unit 107, to be respectively described later, may hold authentication data required for worker matching by biometric authentication (i.e. data in which biometric information and a worker ID are associated).

The skill level storage unit 107 stores a skill level of a worker 3. The skill level indicates a level of skill of a worker 3 in work. A skill level of a worker 3 may be selected from a plurality of skill levels, for example, on the basis of a level of skill of the worker 3 in the work. When a plurality of types of objects 2 exist, the skill level storage unit 107 stores a skill level of a worker 3 for each type of object 2. When a plurality of workers 3 exist, the skill level storage unit 107 may store a skill level for each of the plurality of workers 3.

The skill level storage unit 107 may further store a scale factor for a projection time for each of set skill levels. The scale factor of a projection time indicates a scale factor for changing a projection time of at least one of an indication display, a caution display, and a guidance display on the basis of a skill level of a worker 3. For example, in a case that a scale factor of 0.8 with respect to a skill level having a value of 3 is stored, the projection control unit 103, to be described later, sets a projection time multiplied by 0.8 when a worker with a skill level of 3 is identified. The skill level storage unit 107 may store scale factors not necessarily identical for each of an indication display, a caution display, and a guidance display.

The worker identification unit 108 receives data indicating a worker ID from the worker information acquisition unit 109. The worker identification unit 108 identifies the worker ID on the basis of the received data indicating the worker ID. When data indicating a worker ID take, for example, the form of a signal indicating an input by a worker or a signal obtained by reading an ID card, the worker identification unit 108 converts the signal into the worker ID. When data indicating a worker ID take, for example, the form of biometric information, the worker identification unit 108 identifies the worker ID by biometric authentication. The biometric authentication method may be any one of various existing methods based on a type of biometric information.

The worker identification unit 108 reads a skill level of an identified worker ID from the skill level storage unit 107, and further reads a scale factor for the read skill level from the skill level storage unit 107. When the skill level storage unit 107 stores scale factors not necessarily identical for each of an indication display, a caution display, and a guidance display, with respect to one skill level value, the worker identification unit 108 may read a scale factor for each of the indication display, the caution display, and the guidance display, with respect to the read skill level. The worker identification unit 108 transmits the read scale factor to the projection control unit 103. The worker identification unit 108 may further transmit the worker ID to the projection control unit 103.

The reading unit 101 sequentially reads from the work storage unit 102 a projection data set for each process, which is included in a work procedure for work with respect to an object 2 identified by a received object ID, according to a sequence number of process. The reading unit 101 transmits the read projection data set to the projection control unit 103.

The projection control unit 103 receives a projection data set from the reading unit 101. The projection control unit 103 receives a scale factor from the worker identification unit 108. The projection control unit 103 may set, for example, by multiplying a projection time such as an indication display projection time, a caution display projection time, and a guidance display projection time that are included in the projection data set by the received scale factor.

At least one of an indication display projection time, a caution display projection time, and a guidance display projection time may be predetermined. In that case, a projection data set does not need to include a predetermined projection time among the indication display projection time, the caution display projection time, and the guidance display projection time. The projection control unit 103 may set the projection times, for example, by multiplying a predetermined projection time such as an indication display projection time, a caution display projection time, and a guidance display projection time by the received scale factor.

Then, the projection control unit 103 generates a video image, displayed by the projection unit 104, on the basis of the received projection data set. The video image generated by the projection control unit 103 is a video image in which a visual representation represented by indication display data included in the projection data set is superimposed at a position indicated by the indication display data for a period of an indication display projection time. Then, when the projection data set includes caution display data, the projection control unit 103 superimposes a visual representation represented by the caution display data on the generated video image at a position indicated by the caution display data for a period of a caution display projection time. When the projection data set includes guidance display data, the projection control unit 103 superimposes a visual representation represented by the guidance display data on the generated video image at a position indicated by the guidance display data for a period of a guidance display projection time.

The projection control unit 103 generates a video image so that a visual representation represented by caution display data and a visual representation represented by guidance display data appear before a visual representation represented by indication display data appears in the generated video image. The projection control unit 103 may generate a video image so that a visual representation represented by a caution display data appears after a visual representation represented by a guidance display data appears in the generated video image. Order of appearance of a visual representation represented by a guidance display data and a visual representation represented by a caution display data in the generated video image may be different from the example above.

The projection control unit 103 may generate a video image in which a visual representation of a guidance display and a visual representation of a caution display are both superimposed in at least part of a time period from the beginning to the end of the video image. In other words, the projection control unit 103 may generate a video image including a frame in which a visual representation of a guidance display and a visual representation of a caution display are both superimposed. The projection control unit 103 may generate a video image in which a visual representation of a guidance display or a visual representation of a caution display, and a visual representation of an indication display are both superimposed in at least part of a time period from the beginning to the end of the video image. The projection control unit 103 may generate a video image in which a visual representation of a guidance display, a visual representation of a caution display, and a visual representation of an indication display are both superimposed in at least part of a time period from the beginning to the end of the video image.

Specifically, the projection control unit 103 generates, for example, a video image in which a visual representation represented by indication display data included in a projection data set is superimposed at a position, which is indicated by the indication display data, in the projected video image, for a period of an indication display projection time (i.e. an indication video image). When a projection data set includes caution display data, the projection control unit 103 generates, for example, a video image in which a visual representation represented by the caution display data is superimposed at a position, which is indicated by the caution display data, in the projected video image, for a period of a caution display projection time (i.e. a caution video image). When a projection data set includes guidance display data, the projection control unit 103 generates, for example, a video image in which a visual representation represented by the guidance display data is superimposed at a position, which is indicated by the guidance display data, in the projected video image, for a period of a guidance display projection time (i.e. a guidance video image). Then, the projection control unit 103 may concatenate, for example, in order of the guidance video image, the caution video image, and the indication video image, generated video images in those video images. The projection control unit 103 may generate a video image projected by the projection unit 104 by another method.

When a visual representation represented by indication display data includes an animation, and a projection data set includes an indication display effective time, the projection control unit 103 generates a display video image including a representation by the animation for a period of the indication display effective time from the start of display of the indication display. Additionally, the projection control unit 103 sets a representation of the generated display video image to a static representation when and after the indication display effective time elapses from the start of the display of the indication display. The static representation in that case may be determined in the indication display data.

When a visual representation represented by caution display data includes an animation, and a projection data set includes a caution display effective time, the projection control unit 103 generates a caution video image including a representation by the animation for a period of the caution display effective time from the start of display of the caution display. Additionally, the projection control unit 103 sets a representation of the generated caution video image to a static representation when and after the caution display effective time elapses from the start of the display of the caution display. The static representation in that case may be determined in the caution display data.

When a visual representation represented by guidance display data includes an animation, and a projection data set includes a guidance display effective time, the projection control unit 103 generates a guidance video image including a representation by the animation for a period of the guidance display effective time from the start of display of the guidance display. Additionally, the projection control unit 103 sets a representation of the generated guidance video image to a static representation when and after the guidance display effective time elapses from the start of the display of the guidance display. The static representation in that case may be determined in the guidance display data.

The projection control unit 103 may generate a video image projected by the projection unit 104, by superimposing a visual representation such as a visual representation of a guidance display, a visual representation of a caution display, and a visual representation of an indication display on black or a background video image darker than the superimposed visual representation. The background video image may be a video image in which at least part of a visual representation superimposed in or before an immediately preceding process is superimposed. In that case, the projection control unit 103 changes the visual representation superimposed on the background video image so as to become less conspicuous than a visual representation newly superimposed on the background video image in generation of a video image to be projected, for example, by changing a color and brightness of the visual representation.

The projection control unit 103 projects a generated video image on a region including an object 2 by the projection unit 104. The projection control unit 103 may transmit a generated video image to the projection unit 104 projecting a received video image.

The projection unit 104 is, for example, a projector which is installed above a region including placement locations of an object 2 and a member and projects a received video image on the region including the placement locations of the object 2 and the member. The projection unit 104 receives a video image from the projection control unit 103 and projects the received video image on a region where the object 2 is placed. The video image and the projection unit 104 may be adjusted in advance so that, by the projection unit 104 projecting the video image, a figure and the like indicating a position where work is performed are projected on the position where work is performed.

The projection unit 104 may be a projector changing a projection direction of a received video image, for example, according to control by the projection control unit 103. In that case, the projection control unit 103 controls generation of a video image and a direction of the projection unit 104 so that a visual representation represented by indication display data included in a projection data set is projected at a position indicated by the indication display data. The projection control unit 103 similarly controls generation of a video image and a direction of the projection unit 104 with respect to caution display data and guidance display data that are included in the projection data set.

In that case, the projection control unit 103 specifically operates, for example, as follows. The projection control unit 103 generates a video image to be projected as described above. Then, the projection control unit 103 sets, in the generated video image, a region that can be projected by the projection unit 104 and includes a visual representation represented by data included in a projection data set, in indication display data, caution display data and guidance display data. When a region including all the visual representations is not possible to be set, the projection control unit 103 sets a region including at least visual representations of indication display data and caution display data. Indication display data and caution display data may be generated so that visual representations of the indication display data and the caution display data may be included in a region that can be projected by the projection unit 104. Then, the projection control unit 103 controls a direction of the projection unit 104 so that, for example, the direction of the projection unit 104 is aligned to a direction in which a central pixel of the set region is projected on a region including placement locations of an object 2 and a member. In this case, a relation between a pixel included in the video image and a direction in which the pixel is projected on a region including the placement locations of the object 2 and the member may be obtained in advance. Then, the projection control unit 103 transmits a video image of the set region to the projection unit 104.

The input unit 110 accepts a control instruction that is an instruction input by a worker 3 for controlling progression of a video image such as “REPLAY (e.g. ‘START’ or ‘RESUME’),” “PAUSE,” “RETURN,” “DECELERATION,” and “ACCELERATION.” A control instruction type is expressed by “REPLAY (e.g. ‘START’ or ‘RESUME’),” “PAUSE,” “RETURN,” “DECELERATION,” “ACCELERATION,” and the like. The control instruction according to the respective example embodiments of the present invention, may also be referred to as an “instruction” input by a worker 3. The input unit 110 transmits a signal indicating an accepted control instruction to the instruction reception unit 111. The input unit 110 is achieved, for example, by an input device such as a common keyboard connected to a personal computer to be used. The input unit 110 may be achieved by a specially designed input device.

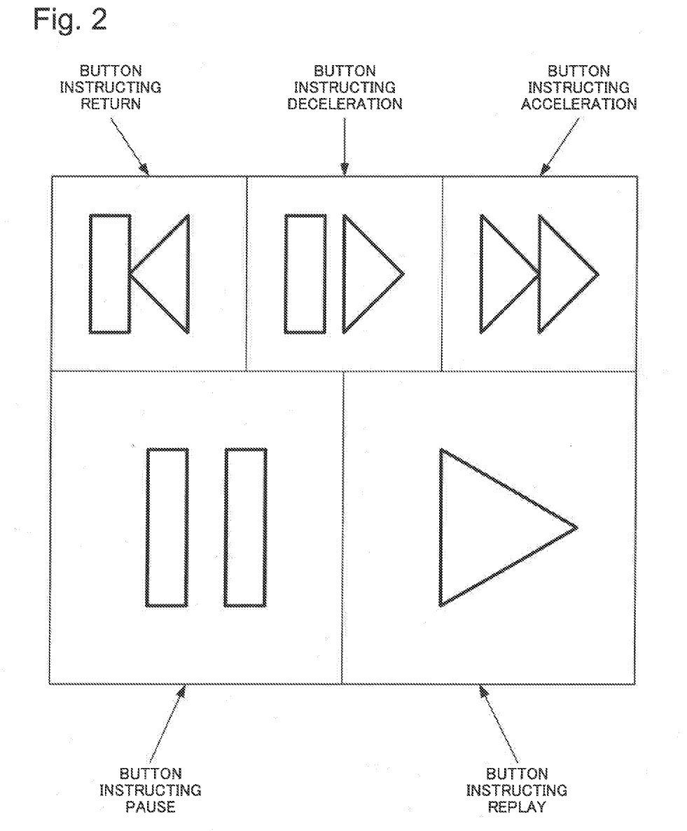

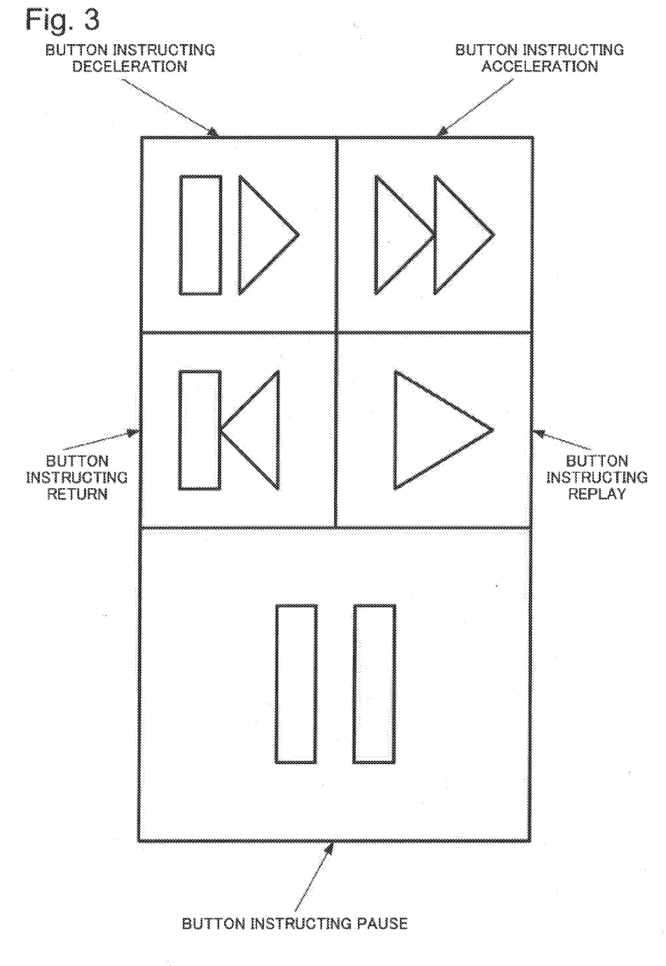

FIGS. 2 and 3 are diagrams illustrating examples of buttons (or keys) included in a specially designed input unit 110. The input unit 110 may be a manually manipulated keyboard including, for example, a button (or a key) illustrated in FIG. 2 or 3. The input unit 110 may be a pedal device being manipulated by foot and including a pedal having a same function as a button illustrated in FIG. 2 or 3. The input unit 110 may be a combination of a pedal device including a pedal having a same function as part of the buttons illustrated in FIG. 2 or 3, and a keyboard including a button (or a key) having a function other than the function of the pedal. The pedal device in that case may include, for example, a pedal instructing PAUSE only. The pedal device in that case may only include, for example, a pedal instructing PAUSE and a pedal instructing REPLAY.

REPLAY is a control instruction to project a video image including an indication display and the like. PAUSE is a control instruction to stop a projected video image, for example, temporarily. START is a control instruction to start projection of a video image including an indication display and the like. RESUME is a control instruction to resume video image projection stopped by PAUSE. RETURN is a control instruction to return a projected video image to a video image in an immediately preceding process. DECELERATION is a control instruction to increase a projection time of an indication display, a caution display, and a guidance display in a video image projected after an instruction being DECELERATION is input. ACCELERATION is a control instruction to decrease a projection time of an indication display, a caution display, and a guidance display in a video image projected after an instruction being DECELERATION is input.

The instruction reception unit 111 receives a signal indicating an accepted control instruction from the input unit 110. The instruction reception unit 111 identifies a control instruction input by a worker on the basis of the received signal. The instruction reception unit 111 transmits the identified control instruction to the projection control unit 103.

When receiving a control instruction from the instruction reception unit 111, the projection control unit 103 projects a video image according to the received control instruction. When a received control instruction is REPLAY, the projection control unit 103 starts projection of a video image including an indication display and the like. When a received control instruction is PAUSE, the projection control unit 103 stops a projected video image. After stopping the video image, the projection control unit 103 may continue displaying a video image frame displayed at reception of the control instruction that is PAUSE. After stopping the video image, the projection control unit 103 may change at least part of a video image displayed at reception of the control instruction that is PAUSE to indicate PAUSE. For example, the projection control unit 103 may indicate PAUSE by reducing brightness of an entire video image displayed at reception of the control instruction being PAUSE. The projection control unit 103 may indicate PAUSE by changing a color of an outer frame of a video image displayed at reception of the control instruction that is PAUSE to another color (e.g. changing from white to red). The projection control unit 103 may superimpose a character string, an image, or the like indicating PAUSE on a video image displayed at reception of the control instruction being PAUSE. When a received control instruction is RESUME, the projection control unit 103 resumes display of a video image. Specifically, the projection control unit 103 resumes video image projection from a frame that is kept continuously displayed.

When a received control instruction is RETURN, the projection control unit 103 discontinues projection of a video image projected at reception of the control instruction that is RETURN. Then, the projection control unit 103 may redo video image projection from a video image projected a predetermined time (e.g. 5 seconds) before the reception time of the control instruction that is RETURN. The predetermined time is set by a designer of the work assistance device 1, or an administrator, a worker 3, or the like of the work assistance device 1. The projection control unit 103 may be configured to store a starting time of video image projection, for example, for each process. Then, the projection control unit 103 identifies a process for which a video image is projected the predetermined time before the reception time of the control instruction that is RETURN, and reads a projection data set of the identified video image. Then, the projection control unit 103 redoes video image projection from the video image projected the predetermined time before the reception time of the control instruction that is RETURN, according to the read projection data set.

When a received control instruction is RETURN, the projection control unit 103 may discontinue projection of a video image projected at reception of the control instruction being RETURN, and redo video image projection from a video image for a process immediately preceding the process for which the video image is projected. An operation of the projection control unit 103 related to a control instruction that is RETURN may be determined by a designer of the work assistance device 1. The work assistance device 1 may be configured so that an administrator, or the like of the work assistance device 1 determines an operation of the projection control unit 103 related to a control instruction that is RETURN. In this case, the projection control unit 103 may read a projection data set for an immediately preceding process through the reading unit 101, and re-generate a video image for the immediately preceding process, according to the read projection data set. The projection control unit 103 may be configured to hold a video image for a process immediately preceding a current process for which a video image is projected. When receiving a control instruction that is RETURN, the projection control unit 103 may project the held video image for the immediately preceding process. The current process (also referred to as a present process) indicates a process for which a projection data set is most recently read or a process for which a projection data set is to be read next, in processes for which video image projection based on a projection data set of the current process is not completed.

When a received control instruction is DECELERATION, the projection control unit 103 may increase a projection time of an indication display, a caution display, and a guidance display by a predetermined fixed time or by a predetermined fixed ratio. When a received control instruction is ACCELERATION, the projection control unit 103 may decrease a projection time of an indication display, a caution display, and a guidance display by a predetermined fixed time or by a predetermined fixed ratio. A maximum value and a minimum value of a projection time may be predetermined. In that case, when a projection time becomes larger than the maximum projection time due to increase based on a control instruction that is DECELERATION, the projection control unit 103 may set the projection time to the maximum projection time. When a projection time becomes smaller than the minimum projection time due to decrease according to a control instruction that is ACCELERATION, the projection control unit 103 may set the projection time to the minimum projection time.

A control instruction may be any one of “ADVANCE,” “CUE,” “NEXT WORK,” and “PREVIOUS WORK.”

A control instruction that is ADVANCE is, for example, an instruction to perform projection from a video image projected a predetermined time after reception of the control instruction. When a received control instruction is ADVANCE, the projection control unit 103 discontinues projection of a video image projected at reception of the control instruction that is ADVANCE. Then, the projection control unit 103 identifies a process for which a video image is projected the predetermined time after the reception of the control instruction, and reads a projection data set for the identified process. The projection control unit 103 resumes video image projection from a video image projected the predetermined time after the reception of the control instruction or later, according to the read projection data set. The control instruction that is ADVANCE may be, for example, an instruction to perform projection from a video image for a process subsequent to a process in which a video image is projected at reception of the control instruction. In that case, after reading the data set of the identified process, the projection control unit 103 starts projection of a video image for the process from the beginning. An operation of the projection control unit 103 related to a control instruction that is ADVANCE may be determined by a designer of the work assistance device 1. The work assistance device 1 may be configured so that an administrator, or the like of the work assistance device 1 determines an operation of the projection control unit 103 related to the control instruction that is ADVANCE.

A control instruction that is CUE is an instruction to resume video image projection from a video image for a first process of a work procedure for which a video image is displayed. When receiving a control instruction that is CUE, the projection control unit 103 discontinues projection of a video image projected at reception of the control instruction that is CUE. Then, the projection control unit 103 resumes video image projection from a video image for a first process included in the same work procedure as a work procedure including a process for which a video image is projected at the reception of the control instruction that is CUE.

A control instruction that is PREVIOUS WORK is an instruction to change the object ID of a work procedure for which a video image is displayed, which is described above, to an object ID immediately preceding the object ID of the work procedure for which a video image is displayed, in a list of a plurality of object IDs. When receiving a control instruction that is PREVIOUS WORK, the projection control unit 103 discontinues projection of a video image projected at reception of the control instruction that is PREVIOUS WORK. Then, the projection control unit 103 identifies an object ID immediately preceding an object ID of a work procedure for which a video image is displayed at the reception of the control instruction that is PREVIOUS WORK. The projection control unit 103 starts video image projection from a first process in a work procedure indicated by the identified object ID.

A control instruction that is NEXT WORK is an instruction to change the object ID of a work procedure for which a video image is displayed, which is described above, to an object ID subsequent to an object ID of the work procedure for which a video image is displayed, in a list of a plurality of object IDs. When receiving a control instruction that is NEXT WORK, the projection control unit 103 discontinues projection of a video image projected at reception of the control instruction that is NEXT WORK. Then, the projection control unit 103 identifies an object ID subsequent to an object ID of a work procedure for which a video image is displayed at the reception of the control instruction that is NEXT WORK. The projection control unit 103 starts video image projection from a first process in a work procedure indicated by the identified object ID.

When receiving a control instruction, the projection control unit 103 stores in the history storage unit 112 a history that is a record including a reception time of the control instruction, an object ID, a sequence number of a process, a worker ID of a worker 3 performing work, and the received control instruction.

The analysis unit 113 analyzes performed control instructions on the basis of histories stored in the history storage unit 112. The control instruction analysis may be derivation of a frequency of each control instruction accumulated, for example, for each process in a work procedure. The control instruction analysis may be derivation of a frequency of each control instruction accumulated, for example, for each time period in which work is performed. The control instruction analysis may be derivation of another statistic, or the like.

The imaging unit 115 captures an image of an area including an object 2. The imaging unit 115 transmits the captured video image to the member detection unit 114. The imaging unit 115 may capture an image of the area including the object 2, for example, immediately before video image projection completes in a current process.

The member detection unit 114 receives an image captured by the imaging unit 115. The member detection unit 114 uses the received video image to determine whether work in a current process is normally performed. For example, when the work in the current process is work of mounting a member on an object 2, the member detection unit 114 may determine whether the work in the current process is normally performed. In that case, the member detection unit 114 may compare, for example, a region including a location where a member is mounted in the current process in the received image with the region in a captured image of the object 2 in a state that the part to be mounted in the current process is normally mounted. Then, the member detection unit 114 may detect an abnormal state such as the member not being mounted, and the member not being mounted in a normal state (e.g. a normal angle). As a detection method, various existing methods of detecting magnitude of a difference between two images, and the like are applicable. When an abnormal state is not detected, the member detection unit 114 may determine that the member is normally mounted.

When the work assistance device 1 is configured so that the member detection unit 114 performs the determination described above, for example, the work storage unit 102 may store, for each procedure ID, a captured image of an object 2 in a state that every member is normally mounted on the object 2. In a description below, a captured image of an object 2 in a state that every member is normally mounted on the object 2 is referred to as a “normal image.” The normal image is an image captured, for example, by the imaging unit 115. The work storage unit 102 may further store a projection data set including a data value indicating a position of a region compared for determining whether or not a member is normally mounted, for each process in which a member is mounted. Then, the reading unit 101 may read a normal image and a data value indicating a position of a region to be compared from the work storage unit 102, and transmit the read normal image and the read data value indicating the position of the region to be compared to the member detection unit 114. The member detection unit 114 cuts out the region to be compared, for example, from each of the normal image and an image captured in the current process by the imaging unit 115. Then, as described above, by comparing images of the region cut out from the aforementioned two images, the member detection unit 114 determines whether or not a member is normally mounted on the object 2.

When an abnormal state is detected, the member detection unit 114 may determine that a member is not normally mounted. When determining that a member is not normally mounted, the member detection unit 114 notifies the projection control unit 103 of the anomaly in mounting of the member.

The projection control unit 103 notified of an anomaly of a member may discontinue projection of a video image including an indication display and project a video image indicating the member not normally mounted. Consequently, a worker 3 is able to identify the member not normally mounted, and therefore is able to normally mount the member not normally mounted.

The projection control unit 103 may reset a projection time on the basis of a time period in which work is performed. For example, when a time period in which work is performed is a time period in which a frequency of control instructions is high, the projection control unit 103 may increase a projection time such as an indication display projection time, a caution display projection time, and a guidance display projection time, for example, by a predetermined ratio or a predetermined time.

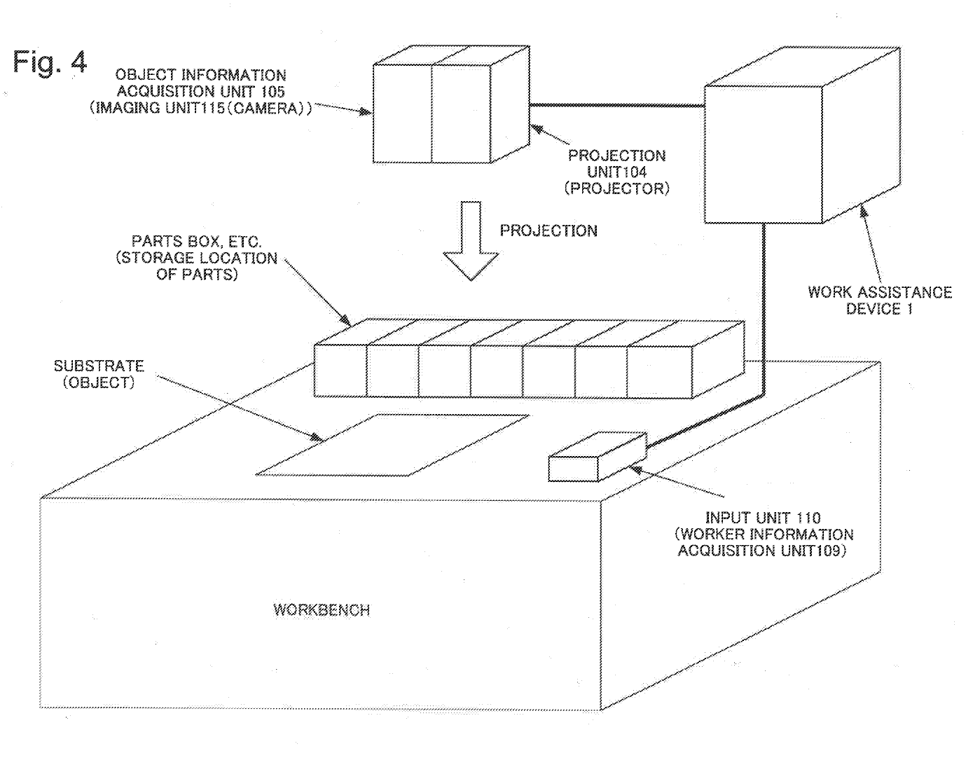

FIG. 4 is a diagram schematically illustrating an example of the work assistance device 1 and a work environment when an object 2 is a substrate and a member is a part and the like mounted on the substrate. As illustrated in FIG. 4, the projection unit 104, the object information acquisition unit 105, the worker information acquisition unit 109, the input unit 110, and the imaging unit 115 may not be included in the work assistance device 1. The projection unit 104, the object information acquisition unit 105, the worker information acquisition unit 109, the input unit 110, and the imaging unit 115 may be connected with the work assistance device 1. In the example illustrated in FIG. 4, a worker 3 performs work such as mounting a part stored in a parts box on a substrate placed on a workbench. The projection unit 104 is a projector immovably mounted above the workbench. The imaging unit 115 is a camera mounted above the workbench and, for example, close to the projection unit 104. The imaging unit 115 also operates as the object information acquisition unit 105. The input unit 110 is a dedicated keyboard designed for the work assistance device 1 and is placed on the workbench. The input unit 110 further has a function as a card reader that reads an ID card storing a worker ID of a worker 3, and also operates as the worker information acquisition unit 109.

Next, an operation of the present example embodiment will be described in detail with reference to drawings.

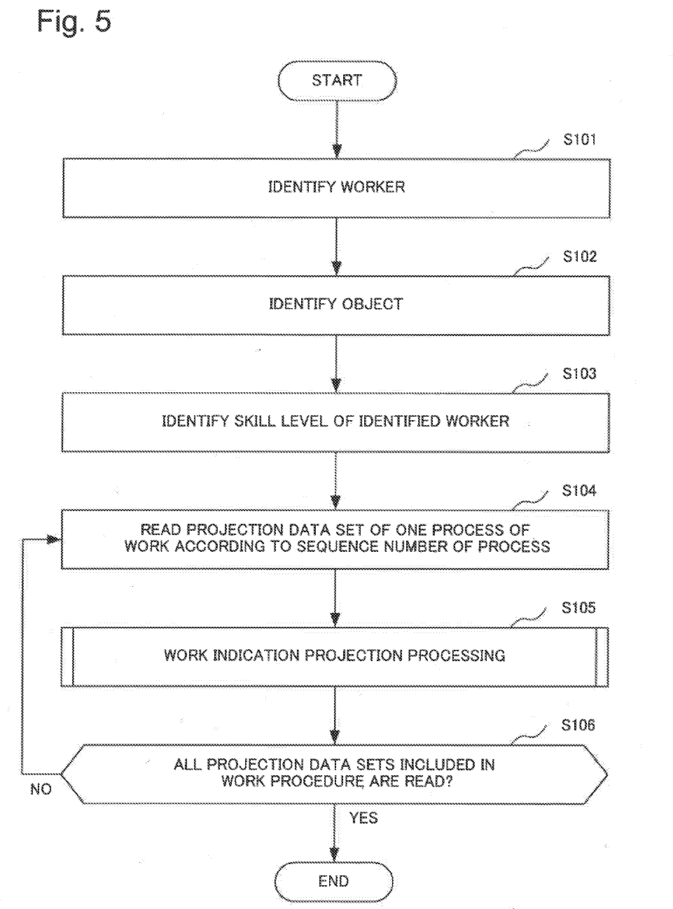

FIG. 5 is a flowchart illustrating an example of an entire operation of projecting a work indication by the work assistance device 1 according to the present example embodiment. The work indication indicates a video image including an indication display and the like generated according to a projection data set included in a work procedure.

Referring to FIG. 5, first, the worker identification unit 108 identifies a worker by identifying a worker ID on the basis of data that indicates the worker ID and is acquired by the worker information acquisition unit 109 (Step S101).

Next, the object identification unit 106 identifies a type of object 2 on the basis of, for example, data that indicates an object ID and is acquired by the object information acquisition unit 105 (Step S102). In the present example embodiment, the object identification unit 106 also identifies, by the object ID, a type of work with respect to the object 2.

Next, the worker identification unit 108 identifies a skill level of the identified worker, for example, by reading a skill level associated with the identified worker ID from the skill level storage unit 107 (Step S103).

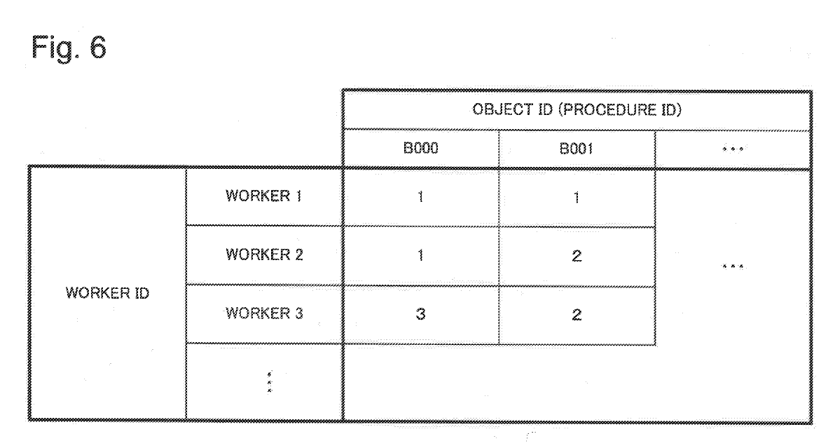

FIG. 6 is a diagram illustrating an example of a skill level of a worker stored in the skill level storage unit 107. In the example illustrated in FIG. 6, WORKER 1, WORKER 2, WORKER 3, and the like are worker IDs. B000, B001, and the like are object IDs (i.e. procedure IDs in each of the example embodiments of the present invention). A numeric value in each row in FIG. 6 indicates a skill level for each worker for each object ID. In the example illustrated in FIG. 6, a greater skill level value indicates a higher skill level of a worker with respect to work.

In Step S103, the worker identification unit 108 further reads from the skill level storage unit 107 a scale factor for each projection time (i.e. an indication display projection time, a caution display projection time, and a guidance display projection time) related to a skill level of the identified worker 3.

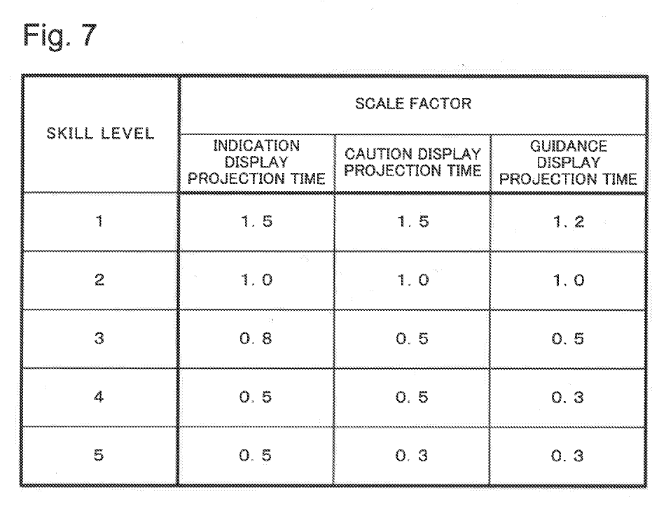

FIG. 7 is a diagram illustrating an example of a scale factor stored in the skill level storage unit 107. A numeric value at the left end of each row in FIG. 7 indicates a skill level. Other numeric values in each row in FIG. 7 indicate scale factors for their respective projection times. For example, when a skill level is 1, a scale factor for an indication display projection time is 1.5, a scale factor for a caution display projection time is 1.5, and a scale factor for a guidance display projection time is 1.2. In work indication projection processing, to be described later, the projection control unit 103 sets each projection time by using a read scale factor. In the example illustrated in FIG. 7, when a skill level of a worker 3 is 1, the projection control unit 103 sets a length of an indication display projection time to the length of a predetermined indication display projection time multiplied by 1.5. Then, the projection control unit 103 sets a length of a caution display projection time to the length of a predetermined caution display projection time multiplied by 1.5. The projection control unit 103 sets a length of a guidance display projection time to the length of a predetermined guidance display projection time multiplied by 1.2.

Next, the reading unit 101 sequentially reads a projection data set of a process of work included in a work procedure identified by the identified object ID, according to a sequence number of the process (Step S104). In other words, the reading unit 101 sequentially reads projection data sets in order from a projection data set with a lower sequence number of process. As described above, projection data sets are stored in the work storage unit 102.

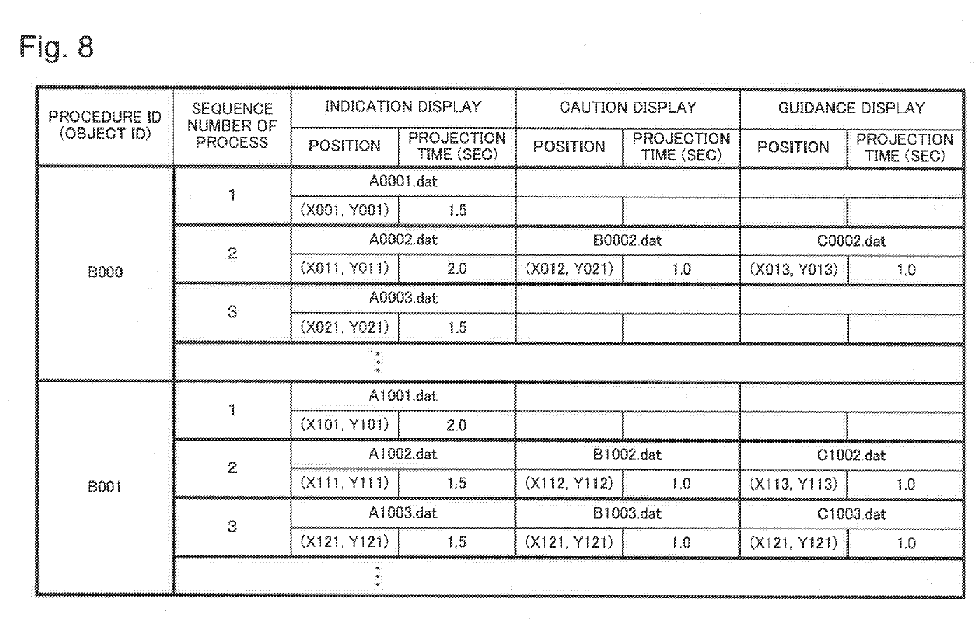

FIG. 8 is a diagram schematically illustrating an example of a work procedure stored in the work storage unit 102.

In the example illustrated in FIG. 8, an indication display, a caution display, and a guidance display are indicated by file names of files storing data representing visual representations of the indication display, the caution display, and the guidance display, respectively. For example, the data representing a visual representation include image data, moving image data, animation data, text data, or a combination thereof. The animation data may be represented by image data, text data, or a combination thereof, and data representing motion.

In the example illustrated in FIG. 8, for example, an indication display for a process whose procedure ID is “B000” and whose sequence number of process is “1” is “A0001.dat.” This “A0001.dat” is a file name of a file storing data representing a visual representation of the indication display. Similarly, for example, a caution display for a process whose procedure ID is “B000” and whose sequence number of process is “2” is “B0002.dat.” For example, a guidance display for a process whose procedure ID is “B000” and whose sequence number of process is “2” is “C0002.dat.”

In the example illustrated in FIG. 8, “POSITION” of an indication display, a caution display, and a guidance display indicate coordinates, in a coordinate system set to a background video image, of positions where the indication display, the caution display, and the guidance display are superimposed on the background video image, respectively. For example, in the example illustrated in FIG. 8, a position where an indication display for a process whose procedure ID is “B000” and whose sequence number of process is “1” is superimposed is “(X001, Y001).” A position where an indication display is superimposed on a background video image is preadjusted so as to indicate a location where work is performed by projecting a video image on which the indication display is superimposed.

For example, “POSITION” of a caution display for a process whose procedure ID is “B000” and whose sequence number of process is “2” is “(X012, Y012).” For example, a position of a caution display may be preselected so that, when a background video image on which the caution display is superimposed is projected, a worker 3 is able to readily and visually recognize the projected caution display. For example, “POSITION” of a guidance display for a process whose procedure ID is “B000” and whose sequence number of process is “2” is “(X013, Y013).” For example, a position of a guidance display may be adjusted so that, when a background video image on which the guidance display is superimposed is projected, the guidance display is shown at a location between a location where work is performed in an immediately preceding process and a location where work is performed in a current process.

“PROJECTION TIME” of an indication display, a caution display, and a guidance display indicates periods of time for which the indication display, the caution display, and the guidance display are superimposed, respectively, on a background video image. In the example illustrated in FIG. 8, for example, a projection time of an indication display for a process whose procedure ID is “B000” and whose sequence number of process is “1” is 1.5 seconds. For example, a projection time of a caution display for a process whose procedure ID is “B000” and whose sequence number of process is “2” is 1.0 second. For example, a projection time of a guidance display for a process whose procedure ID is “B000” and whose sequence number of process is “2” is 1.0 second.

In the example illustrated in FIG. 8, when a file name of data representing a visual representation of a caution display does not exist in a projection data set, a visual representation of a caution display for the process does not exist. A projection data set read by the reading unit 101 for that process does not include data representing a visual representation of a caution display, a position of a caution display, and a projection time of a caution display. A visual representation of a caution display is not superimposed on a background video image for that process. When a file name of data representing a visual representation of a guidance display does not exist in a projection data set, a visual representation of a guidance display does not exist for the process. A projection data set read by the reading unit 101 for that process does not include data representing a visual representation of a guidance display, a position of a guidance display, and a projection time of a guidance display. A visual representation of a guidance display is not superimposed on a background video image for the process.

For example, for a process whose procedure ID is “B000” and whose sequence number of process is “1,” the reading unit 101 reads a projection data set including a file storing data representing a visual representation of an indication display, and a position and a projection time of the indication display. For a process whose procedure ID is “B000” and whose sequence number of process is “2,” the reading unit 101 reads a projection data set including files storing data representing visual representations, positions and projection times of an indication display, a caution display, and a guidance display.

Next, the projection control unit 103 performs work indication projection processing (Step S105). The work indication projection processing will be described in detail later.

When projection data sets of all processes included in the work procedure are read (YES in Step S106), the work assistance device 1 ends the operation illustrated in FIG. 5. When at least one of the projection data sets in all the processes included in the work procedure is not read (NO in Step S106), the work assistance device 1 repeats the operations in and after Step S104.

Next, an operation of the work indication projection processing by the work assistance device 1 according to the present example embodiment will be described in detail with reference to drawings.

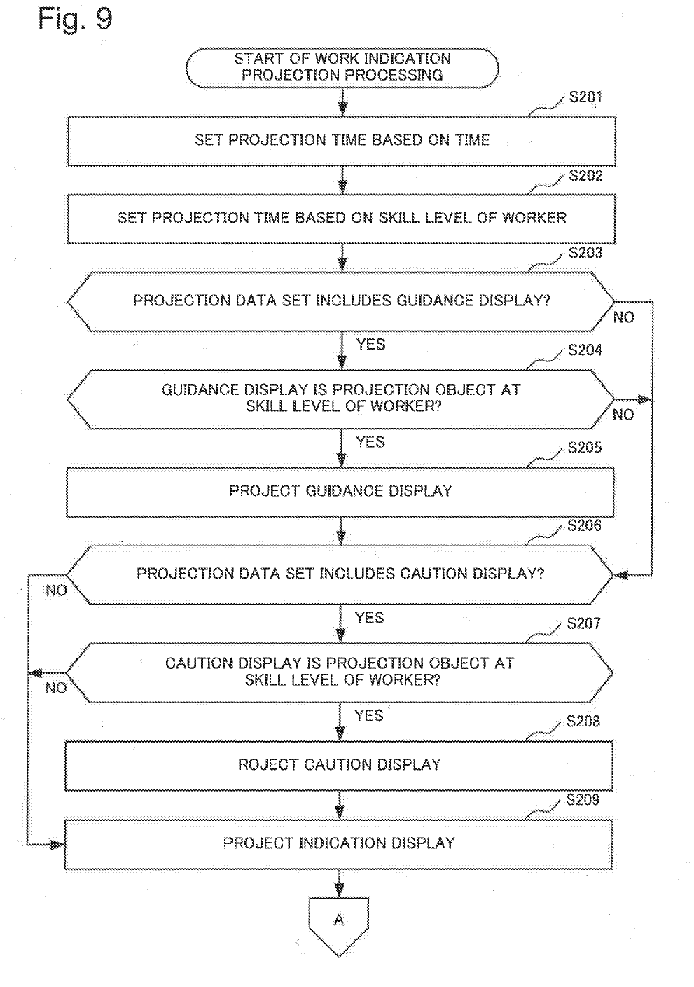

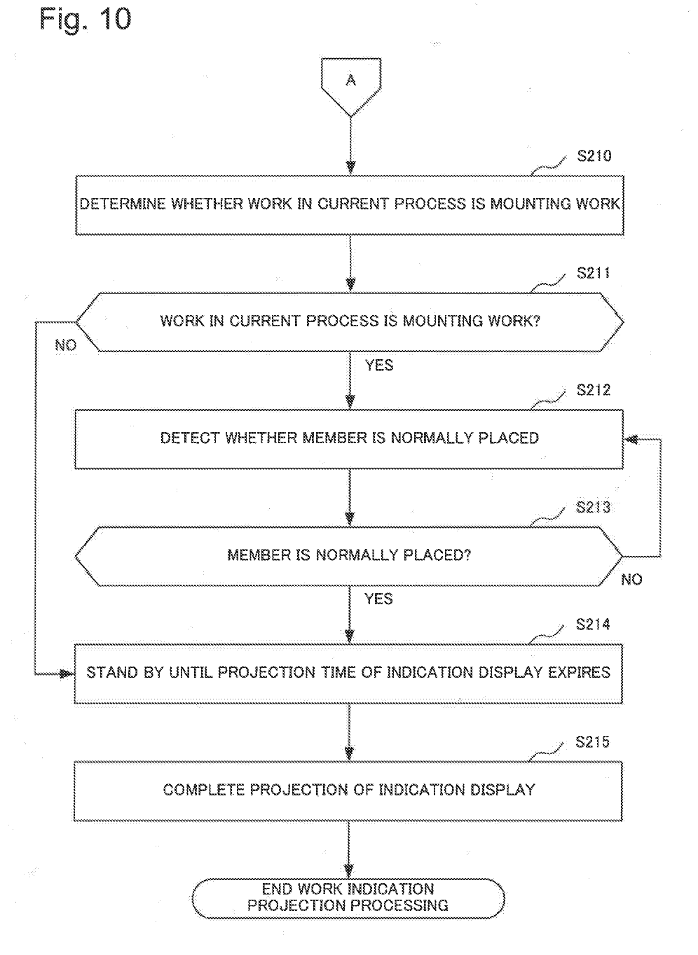

FIGS. 9 and 10 are flowcharts illustrating an operation example of the work indication projection processing by the work assistance device 1 according to the present example embodiment.

First, the projection control unit 103 identifies a time and sets a projection time on the basis of the identified time (Step S201). For example, when a scale factor for a projection time is set on the basis of a time period, the projection control unit 103 multiplies each of an indication display projection time, a caution display projection time, and a guidance display projection time that are included in a projection data set by a scale factor set on the basis of the time period. When the projection data set does not include a caution display projection time, the projection control unit 103 does not multiply a caution display projection time by a scale factor. In other words, the projection control unit 103 does not set a caution display projection time. When the projection data set does not include a guidance display projection time, the projection control unit 103 does not multiply a guidance display projection time by a scale factor. In other words, the projection control unit 103 does not set a guidance display projection time.

The time periods may be, for example, time periods separated into the morning and the afternoon. Then, a scale factor larger than a scale factor for a time period of the morning may be set for a time period of the afternoon when a worker 3 becomes distracted. Time periods and scale factors other than the example above may be set. A scale factor based on a time period may not be set. An indication display projection time, a caution display projection time, and a guidance display projection time may be set with an identical scale factor. The display indication projection time, the caution display projection time, and the guidance display projection time may be set with scale factors not necessarily identical, respectively. In that case, the projection control unit 103 does not perform the operation in Step S201.

Next, the projection control unit 103 sets a projection time based on a skill level of a worker 3, where the skill level is read from the skill level storage unit 107 by the worker identification unit 108 and is transmitted to the projection control unit 103 (Step S202). The projection control unit 103 multiplies each of the indication display projection time, the caution display projection time, and the guidance display projection time, which are set, by a scale factor based on the skill level of the worker 3. When the projection data set does not include a caution display projection time, the projection control unit 103 does not multiply a caution display projection time by a scale factor. In other words, the projection control unit 103 does not set a caution display projection time. When the projection data set does not include a guidance display projection time, the projection control unit 103 does not multiply a guidance display projection time by a scale factor. In other words, the projection control unit 103 does not set a guidance display projection time.

An example of a skill level of the worker 3 is illustrated, for example, in FIG. 7 mentioned above. As illustrated in FIG. 7, a scale factor based on a skill level may be identical for an indication display projection time, a caution display projection time, and a guidance display projection time. A scale factor based on a skill level may not necessarily be identical for the indication display projection time, the caution display projection time, and the guidance display projection time. A scale factor based on a skill level may be 0.0.

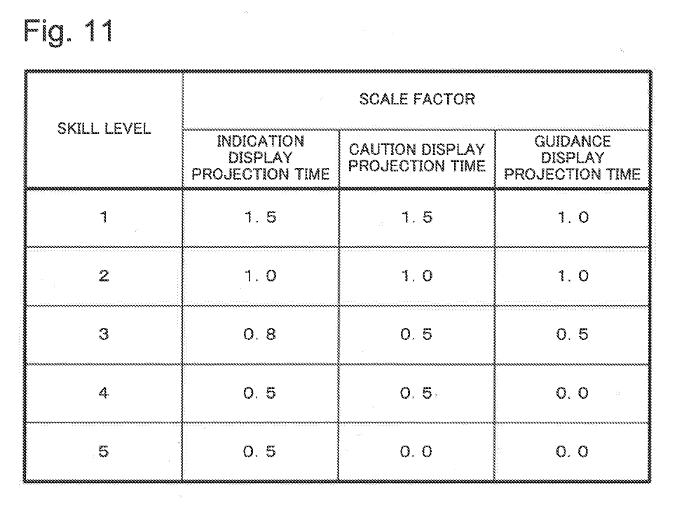

FIG. 11 is a diagram illustrating an example of a scale factor stored in the skill level storage unit 107 according to the first example embodiment of the present invention. In the example illustrated in FIG. 11, when a skill level is 4 or 5, a scale factor for a guidance display projection time is 0.0. In the example illustrated in FIG. 11, when a skill level of a worker 3 is 4 or 5, a guidance display is not projected. When a skill level is 5, a scale factor for a caution display projection time is 0.0. In the example illustrated in FIG. 11, when a skill level of a worker 3 is 5, a caution display is not projected.

When the projection data set does not include a guidance display (NO in Step S203), or when a guidance display is not a projection object at the skill level of the worker 3 (NO in Step S204), the operation of the work assistance device 1 proceeds to Step S206.

As described above, when the projection data set does not include a guidance display, a guidance display is not projected. Even in a case that the projection data set includes a guidance display, when a scale factor for the guidance display projection time at the skill level of the worker 3 is 0.0, a guidance display is not projected. In other words, a guidance display is not a projection object. In contrast, when the projection data set includes a guidance display, and, further, a scale factor for the guidance display projection time at the skill level of the worker 3 is not 0.0, a guidance display is projected. In other words, a guidance display is a projection object.

When the projection data set includes a guidance display (YES in Step S203), and, further, a guidance display 3 is a projection object at the skill level of the worker (YES in Step S203), the projection control unit 103 projects a guidance display (Step S205). Specifically, the projection control unit 103 superimposes a guidance display on a background video image, and transmits a video image in which the guidance display is superimposed on the background video image to the projection unit 104. The projection unit 104 projects the received video image on a region including a location where work is performed. In Step S205, the projection control unit 103 may project the guidance display for a period of the guidance display projection time.

When the work assistance device 1 is configured not to provide a guidance display, the projection control unit 103 does not perform the operations in Steps S203 to S205.

When the projection data set does not include a caution display (NO in Step S206), or when a caution display is not a projection object at the skill level of the worker 3 (NO in Step S207), the operation of the work assistance device 1 proceeds to Step S209.

As described above, when the projection data set does not include a caution display, a caution display is not projected. Even in a case that the projection data set includes a caution display, when a scale factor for the caution display projection time at the skill level of the worker 3 is 0.0, a caution display is not projected. In other words, a caution display is not a projection object. In contrast, when the projection data set includes a caution display, and, further, a scale factor for the caution display projection time at the skill level of the worker 3 is not 0.0, a caution display is projected. In other words, a caution display is a projection object.

When the projection data set includes a caution display (YES in Step S206), and, further, a caution display is a projection object at the skill level of the worker 3 (YES in Step S207), the projection control unit 103 projects a caution display (Step S208). Specifically, the projection control unit 103 superimposes a caution display, for example, on a background video image, and transmits a video image in which the caution display is superimposed on the background video image to the projection unit 104. The projection unit 104 projects the received video image on a region including a location where work is performed. In Step S208, the projection control unit 103 may project the caution display for a period of the caution display projection time.

In addition to the indication display projection time, the caution display projection time, and the guidance display projection time, the projection data set may include, for example, an indication display start time, a caution display start time, and a guidance display start time.

In this case, the indication display start time indicates a time period from a start of projection of a video image based on the projection data set including the indication display start time to a start of projection of an indication display. When the indication display start time elapses from the start of the projection of the video image based on the projection data set including the indication display start time, the projection control unit 103 starts projection of the indication display. In other words, the projection control unit 103 starts to superimpose the indication display on the video image transmitted to the projection unit 104.

The caution display start time indicates a time period from a start of projection of a video image based on a projection data set including the caution display start time to a start of projection of a caution display. When the caution display start time elapses from the start of the projection of the video image based on the projection data set including the caution display start time, the projection control unit 103 starts projection of the caution display. In other words, the projection control unit 103 starts to superimpose the caution display on the video image transmitted to the projection unit 104.

The guidance display start time indicates a time period from a start of projection of a video image based on a projection data set including the guidance display start time to a start of projection of a guidance display. When the guidance display start time elapses from the start of the projection of the video image based on the projection data set including the guidance display start time, the projection control unit 103 starts projection of the guidance display. In other words, the projection control unit 103 starts to superimpose the guidance display on the video image transmitted to the projection unit 104.

In the cases described above, at least two of an indication display, a caution display, and a guidance display may be superimposed on a same frame in a video image transmitted to the projection unit 104.

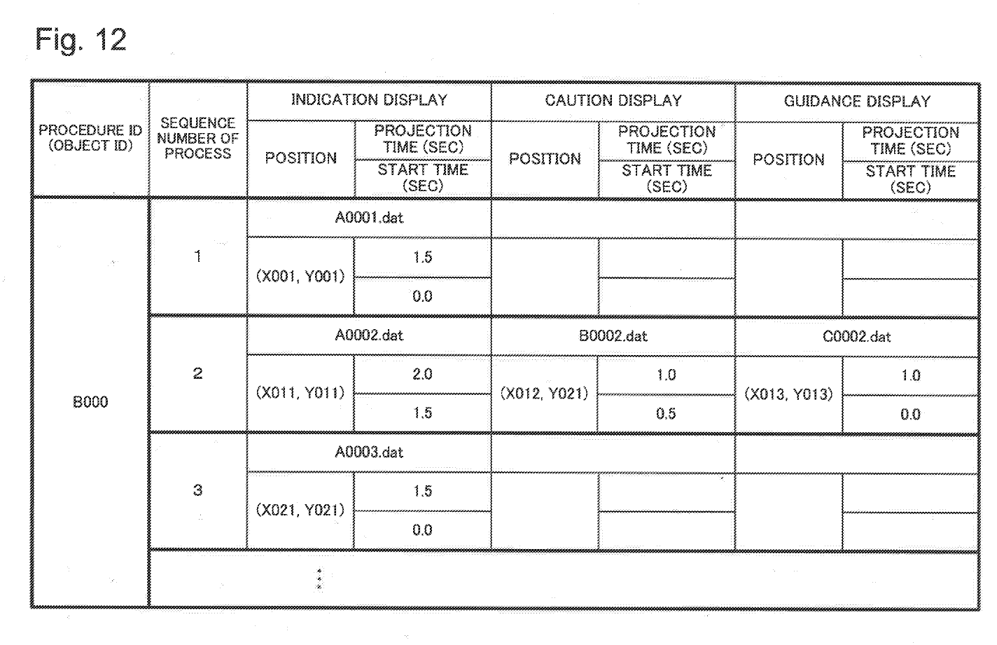

FIG. 12 is a diagram schematically illustrating an example of a work procedure stored in the work storage unit 102. In the work procedure illustrated in FIG. 12, a projection data set includes a start time of a display. In the example illustrated in FIG. 12, a start time of an indication display is the aforementioned indication display start time. A start time of a caution display is the aforementioned caution display start time. A start time of a guidance display is the aforementioned guidance display start time.

For example, in a process whose sequence number of process is “2” in a work procedure whose procedure ID is “B000” represented in FIG. 12, a guidance display is superimposed on a video image based on a projection data set of the process for a period from a start of projection of the video image until 1.0 second elapses. In the same process, a caution display is superimposed on the video image after 0.5 seconds elapses from the start of the video image projection. In this example, the guidance display and the caution display are superimposed on a same frame in the video image for a period from a time when 0.5 seconds elapses from the start of the video image projection until a time when 1.0 second elapses from the start of the video image projection.

When a guidance display and a caution display are projected on a same frame in a video image, for example, the projection control unit 103 may additionally superimpose the caution display on a frame in the video image in which the guidance display is superimposed on a background video image.

In Step S209, the projection control unit 103 projects an indication display for a period of the indication display projection time (Step S209). Specifically, the projection control unit 103 superimposes, for example, the indication display on a background video image, and transmits a video image in which the indication display is superimposed on the background video image to the projection unit 104. The projection unit 104 projects the received video image on a region including a location where work is performed. In Step S209, the projection control unit 103 may project the indication display for a period of the indication display projection time.

In the example illustrated in FIG. 12, an indication display is not superimposed with a guidance display and a caution display in a same process on a same frame in a video image. An indication display is not projected together with a guidance display and a caution display. However, an indication display may be superimposed with at least either of a guidance display or a caution display for a same process on a same frame in a video image. However, as described above, after a caution display starts to be superimposed on a video image, an indication display in a same process starts to be superimposed on the video image. In other words, after a caution display starts to be projected, an indication display in a same process starts to be projected. Before projection of an indication display completes, projection of a caution display and a guidance display for a same process completes. When at least either of a guidance display or a caution display is superimposed with an indication display on a same frame in a video image the projection control unit 103 may additionally superimpose, for example, an indication display on a video image in which at least either of a guidance display or a caution display is superimposed on a background video image.

After the operation in Step S209, the work assistance device 1 performs operations in and after Step S210 indicated in FIG. 10.

For example, work performed by a worker 3 may include a process in which normal completion of work can be determined on the basis of a captured image of a region including an object 2 of the work, such as a process of mounting a part on a substrate. When the work performed by the worker 3 includes such a process, the work assistance device 1 may perform operations of Steps S210 to S213 represented in FIG. 10. When the work performed by the worker 3 does not include such a process, the work assistance device 1 does not perform the operations of Steps S210 to S213 shown in FIG. 10. In that case, after the operation in Step S209, the work assistance device 1 performs operations in and after Step S214. A description below will mainly describe a case that the work performed by the worker 3 includes a process in which normal completion of the work can be determined on the basis of an image, and the process is a process of mounting a part on a substrate.

First, the projection control unit 103 determines whether or not work in a current process is mounting work (Step S210).

The work storage unit 102 may store in advance, for each process, a projection data set including a value indicating whether or not work in the process is work of mounting a part on a substrate (i.e. mounting work). Then, the projection control unit 103 may determine whether or not work in the current process is mounting work on the basis of a value indicating whether or not work is mounting work and being included in a projection data set in the current process.

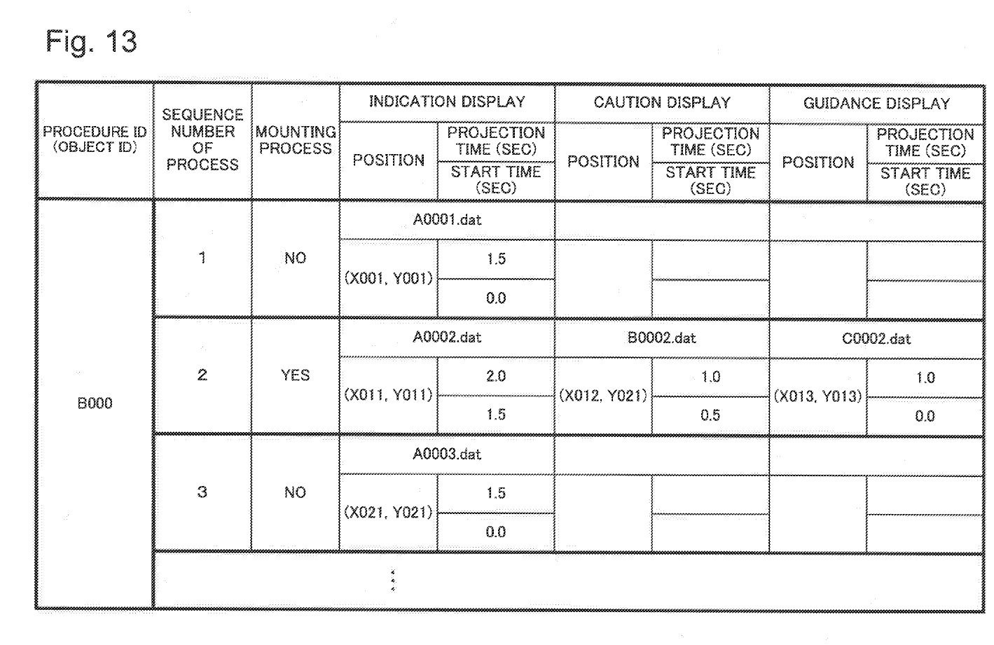

FIG. 13 is a diagram schematically illustrating an example of a work procedure stored in the work storage unit 102.

In the example illustrated in FIG. 13, “MOUNTING PROCESS” indicates whether or not work in a process is work of mounting a part on a substrate (i.e. mounting work). Work in a process whose value of “MOUNTING PROCESS” is “YES” is mounting work. A process whose value of “MOUNTING PROCESS” is “NO” is not mounting work. Values “YES” and “NO” may be different values set in advance.

When work in the current process is mounting work (YES in Step S211), the member detection unit 114 detects, on the basis of an image captured by the imaging unit 115, whether a member to be equipped in the work in the present process is normally equipped (Step S212).

When the member is not detected to be normally equipped (NO in Step S213), the member detection unit 114 continues detection of whether or not the member is normally equipped (Step S212). In this case, for example, the projection control unit 103 may superimpose a display indicating that the member is not normally equipped on a video image projected by the projection unit 104.

When the member is detected to be normally equipped (YES in Step S213), the projection control unit 103 stands by until the projection time of an indication display expires (Step S214). When the projection time of the indication display has already expired in Step S214, the projection control unit 103 does not stand by.

When the work in the current process is not mounting work (NO in Step S211), the work assistance device 1 next performs an operation in Step S214.

When the projection time of the indication display expires, the projection control unit 103 completes projection of the indication display (Step S215). As described above, even when a time period in which at least either of a caution display or a guidance display, and an indication display are projected together, projection of the caution display and the guidance display completes no later than completion of projection of the indication display.

Next, a case that a visual representation is represented by an animation will be described.

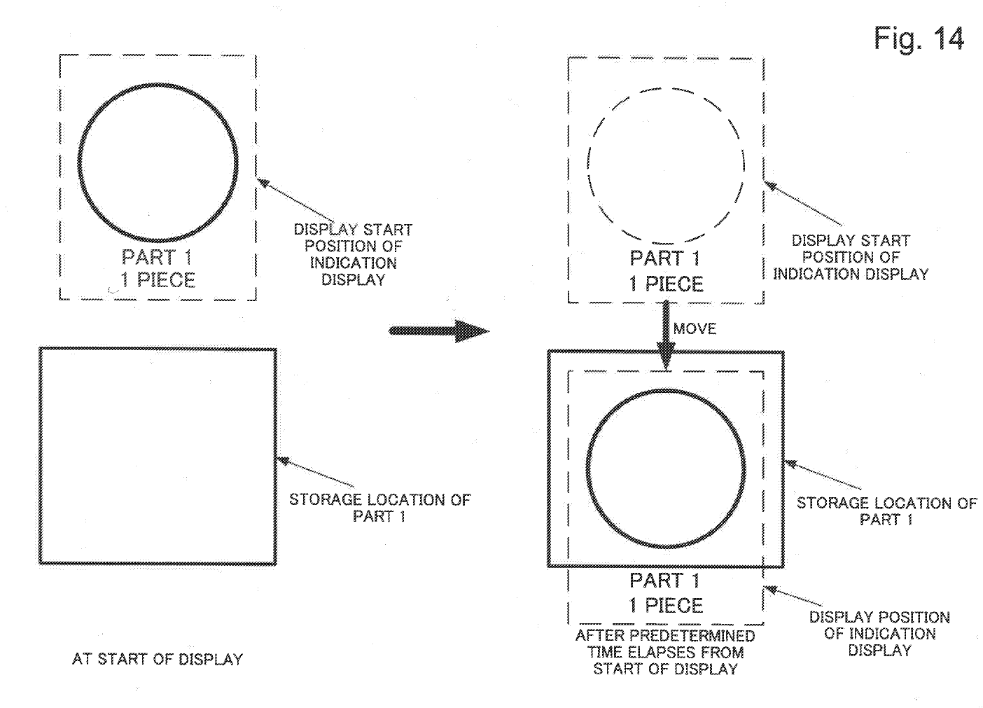

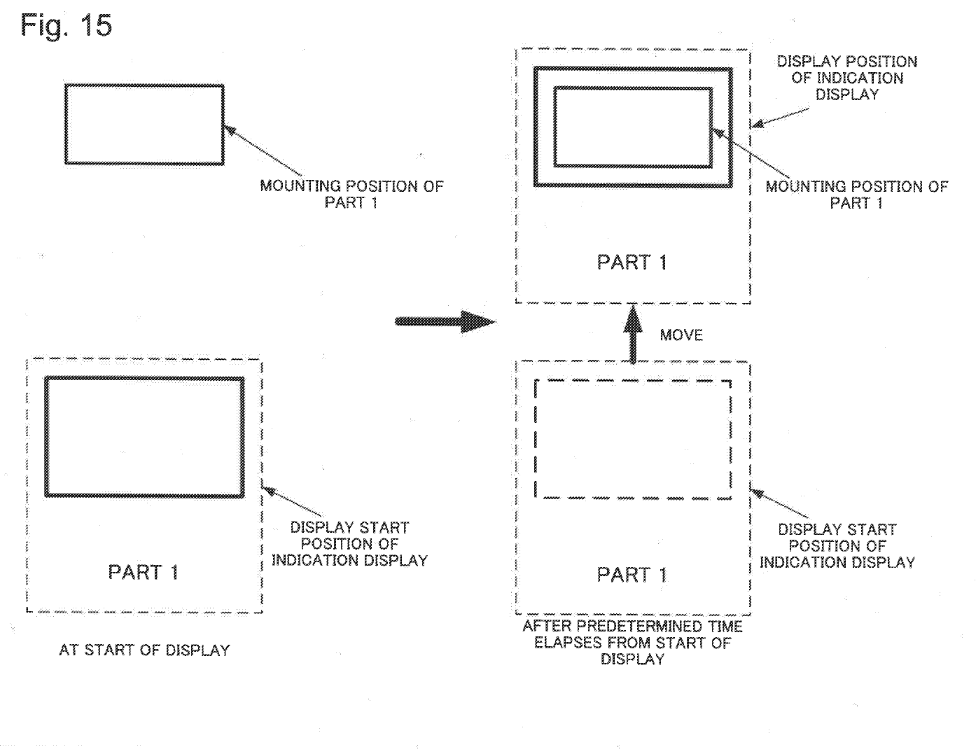

FIGS. 14 and 15 are diagrams illustrating examples of visual representations represented by animations. FIGS. 14 and 15 respectively illustrate examples of an indication display projected in Step S209 when the work is mounting of a part on a substrate.

Specifically, FIG. 14 illustrates an example of a motion of an indication display when work in a current process is work of taking out a part 1 from a location where the part 1 is stored. The left side of FIG. 14 illustrates an example of the indication display projected at a start of display. The right side of FIG. 14 illustrates the indication display moving from a projection position at the start of the display to a final display position. A circle, a character string “PART 1,” and a character string “1 PIECE” are included in the indication display.

In the example illustrated in FIG. 14, at the start of projection of the indication display, the indication display is projected above the storage location of the part 1. Then, for example, after a predetermined time elapses, the indication display gradually moves downward so that the circle is projected on the storage location of the part 1, as illustrated on the right side of FIG. 14. Then, the indication display stops. The circle is projected on the storage location of the part 1 until the indication display projection time expires, as illustrated on the right side of FIG. 14. As described above, the indication display does not necessarily need to be projected on a storage location of a member such as the part 1. For example, the indication display may be projected close to the storage location of a member such as the part 1.

The example illustrated in FIG. 15 illustrates an example of a motion of an indication display when work in a current process is work of mounting a part 1 on a substrate. In the example illustrated in FIG. 15, the indication display includes a rectangle and a character string “PART 1.” Similarly to FIG. 14, the left side of FIG. 15 illustrates an example of the indication display projected at a start of display of the indication display. The right side of FIG. 15 illustrates an example of the indication display moving from a projection position at the start of the display to a final display position.

In the example illustrated in FIG. 15, the indication display is projected below an installation position of the part 1 at the start of projection of the indication display. Then, for example, after a predetermined time elapses, the indication display gradually moves upward so that the rectangle is projected on the installation position of the part 1, as illustrated on the right side of FIG. 15. Then, the indication display stops. The rectangle is projected on the installation position of the part 1 until the indication display projection time expires, as illustrated on the right side of FIG. 15.

For example, the visual representations of the indication display illustrated in FIGS. 14 and 15 may be made as a description in an existing animation description language. Then, by interpreting the description, the projection control unit 103 may generate a video image on which the indication display is superimposed.

FIGS. 5, 9, and 10 described above illustrate operations of the work assistance device 1 when a worker 3 does not input a control instruction by using the input unit 110.

Next, an operation of the work assistance device 1 when a worker 3 inputs a control instruction by using the input unit 110 will be described in detail with reference to drawings.

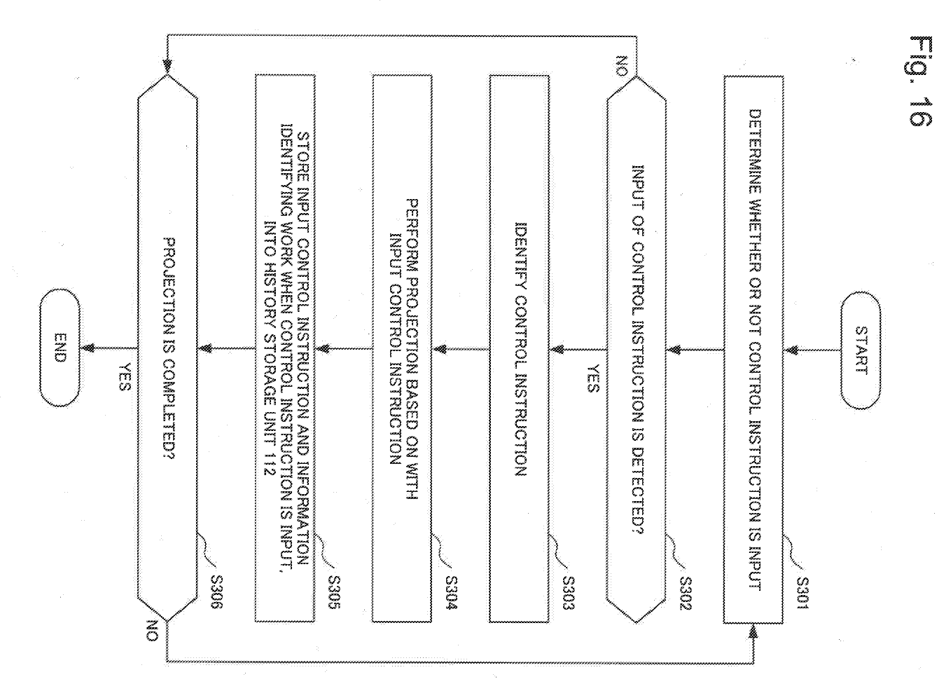

FIG. 16 is a flowchart illustrating an operation example of the work assistance device 1 according to the present example embodiment when a control instruction is input by a worker 3. The operation illustrated in FIG. 16 is performed in parallel with the operations illustrated in FIGS. 5, 9, and 10.

First, the instruction reception unit 111 determines whether or not a control instruction is input by a worker 3 by using the input unit 110 (Step S301).

When input of a control instruction is not detected (NO in Step S302), and, further, projection is not completed (NO in Step S306), the instruction reception unit 111 continues determination of whether or not a control instruction is input (Step S301). When input of a control instruction is not detected (NO in Step S302), and, further, the projection is completed (YES in Step S306), the work assistance device 1 ends the operation illustrated in FIG. 16.

When input of a control instruction is detected (YES in Step S302), the instruction reception unit 111 identifies the input control instruction (Step S303). The instruction reception unit 111 transmits the identified control instruction to the projection control unit 103.

The projection control unit 103 performs projection according to the input control instruction (Step S304).

For example, when the input control instruction is “START,” the work assistance device 1 starts the operations illustrated in FIGS. 5, 9, and 10.

For example, when the input control instruction is “PAUSE,” the projection control unit 103 stops, for example, a timer measuring a projection time, and, further, stops updating of a video image transmitted to the projection unit 104. While the updating of a video image transmitted to the projection unit 104 is stopped, the projection control unit 103 continues transmitting a last generated video image to the projection unit 104.

For example, when the input control instruction is “RESUME,” the projection control unit 103 resumes a stopped timer, and, further, resumes the updating of a video image transmitted to the projection unit 104.

The worker 3 may perform input of “START” and input of “RESUME” by inputting a same control instruction (i.e. “REPLAY” in the following description). In that case, for example, when a control instruction “REPLAY” is detected in a state that the work assistance device 1 is not performing the operations illustrated in FIGS. 5, 9, and 10, the instruction reception unit 111 may determine that “START” described above is input. When a control instruction “REPLAY” is detected in a state that a timer and updating of a video image are stopped by a control instruction “PAUSE,” the instruction reception unit 111 may determine that “RESUME” described above is input. When “REPLAY” is detected in any other state, the instruction reception unit 111 may not detect the control instruction indicating “REPLAY” as a control instruction.

For example, when the input control instruction is “DECELERATION,” the projection control unit 103 increases a scale factor for each projection time of an indication display projection time, a caution display projection time, and a guidance display projection time, in accordance with a predetermined rule.

For example, when the input control instruction is “ACCELERATION,” the projection control unit 103 decreases a scale factor for each projection time of an indication display projection time, a caution display projection time, and a guidance display projection time, in accordance with a predetermined rule.

For example, when the input control instruction is “RETURN,” the projection control unit 103 re-projects, by the projection unit 104, a video image on which an indication display and the like in an immediately preceding process are superimposed.

Next, the projection control unit 103 stores in the history storage unit 112 a control instruction history including an input control instruction and information identifying work when the control instruction is input (Step S305).

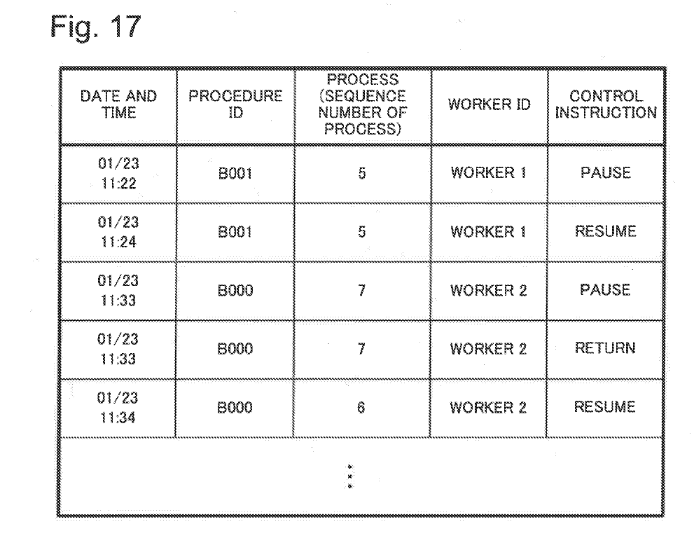

FIG. 17 is a diagram schematically illustrating an example of a history stored in the history storage unit 112.

Each column in FIG. 17 indicates a history. In the example illustrated in FIG. 17, “WORKER ID” indicates a worker ID of a worker inputting a control instruction. “CONTROL INSTRUCTION” indicates a type of input control instruction. “PROCEDURE ID” indicates a procedure ID identifying a work procedure of work performed when a control instruction is input. “PROCESS (SEQUENCE NUMBER OF PROCESS)” indicates a sequence number of a process in a work procedure thereof when a control instruction is input. A process in which a control instruction is input can be identified by “PROCEDURE ID” and “PROCESS (SEQUENCE NUMBER OF PROCESS).” In the respective example embodiments of the present invention, information identifying a process in which a control instruction is input is also referred to as “process identification information.” In the example illustrated in FIG. 17, process identification information is a combination of “PROCEDURE ID” and “PROCESS (SEQUENCE NUMBER OF PROCESS).”

For example, a row whose “DATE AND TIME” is “01/23 11:22” shown in FIG. 17 is a history of a control instruction input by a worker 3 whose worker ID is “WORKER 1.” In the history, the control instruction input by the worker 3 is “PAUSE.” A process when the instruction is input is a process whose sequence number of process is “5” in work whose procedure ID is “B001.” A date and time when the instruction is received is 11:22 AM on January 23 represented as “01/23 11:22.” “DATE AND TIME” may be a date and time when the instruction reception unit 111 receives an instruction. In that case, the instruction reception unit 111 may transmit a date and time when the instruction is received to the projection control unit 103. “DATE AND TIME” may be a time when the projection control unit 103 receives an identified instruction from the instruction reception unit 111.

When projection is completed (YES in Step S306), the work assistance device 1 ends the operation illustrated in FIG. 16.

For example, the analysis unit 113 extracts, for example, at a predetermined time, a time period in which, for example, a control instruction “PAUSE” and a control instruction “RETURN” are frequently detected on the basis of a history stored in the history storage unit 112. Then, the analysis unit 113 outputs the extracted time period, for example, to an output device (unillustrated) of the work assistance device 1. For example, an administrator of the work assistance device 1 may set a scale factor for each time period in the projection control unit 103 on the basis of the output by the analysis unit 113.

### Projection Examples

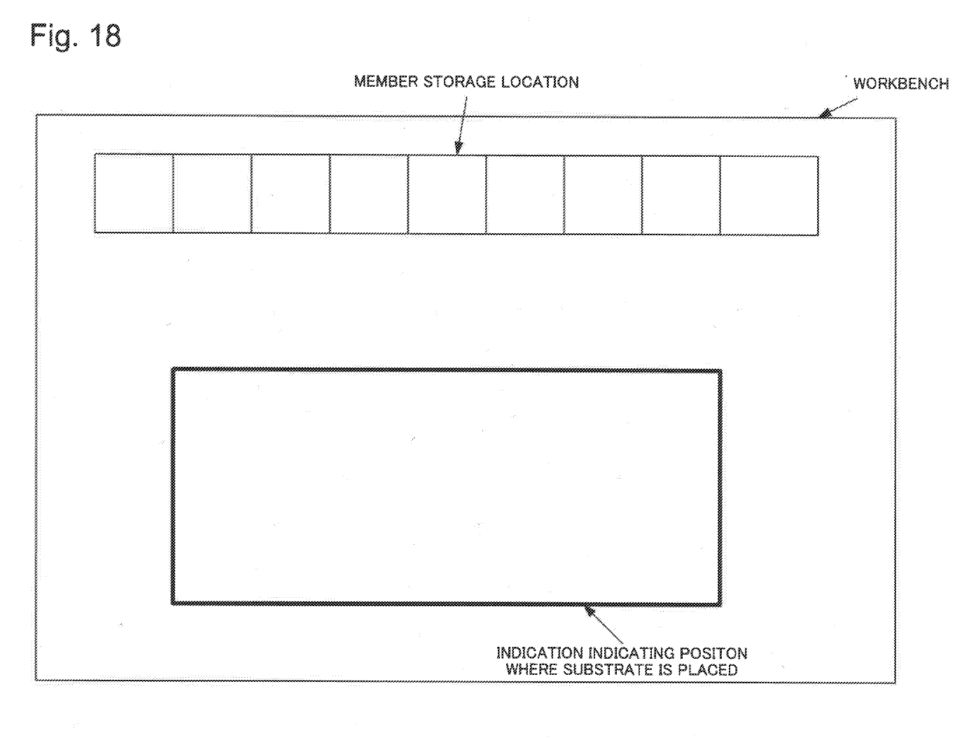

Each drawing from FIG. 18 to FIG. 35 is a diagram schematically illustrating an example of an indication display, a caution display, and a guidance display that are projected by the projection control unit 103 in Step S209 in FIG. 9 in consecutive processes. In those drawings, work is work of installing a part that is a member on a substrate that is an object 2 of the work.

FIG. 18 is an example of an indication display displayed first. FIG. 18 is a top view of a workbench on which a substrate is placed. A worker 3 is positioned below the workbench in FIG. 18. A member storage location such as a location where a part is stored (e.g. a parts box) is positioned above the location where a substrate is placed.

The projection control unit 103 first projects, on the workbench, an indication display indicating a position where a substrate is placed. The worker 3 places a substrate at a position indicated by the indication display. When a substrate to be placed is predetermined, the projection control unit 103 may project a location where the substrate is placed. When a substrate to be installed is not determined, for example, the object identification unit 106 may first identify a type of substrate put on the workbench by the worker 3. Then, the projection control unit 103 may project, on the workbench, an indication display indicating a position where the substrate is placed on the basis of the identified type of the substrate. Positions in an indication display, a caution display, a guidance display, and the like that are subsequently projected may be determine on the assumption that a substrate is placed at a projected position.

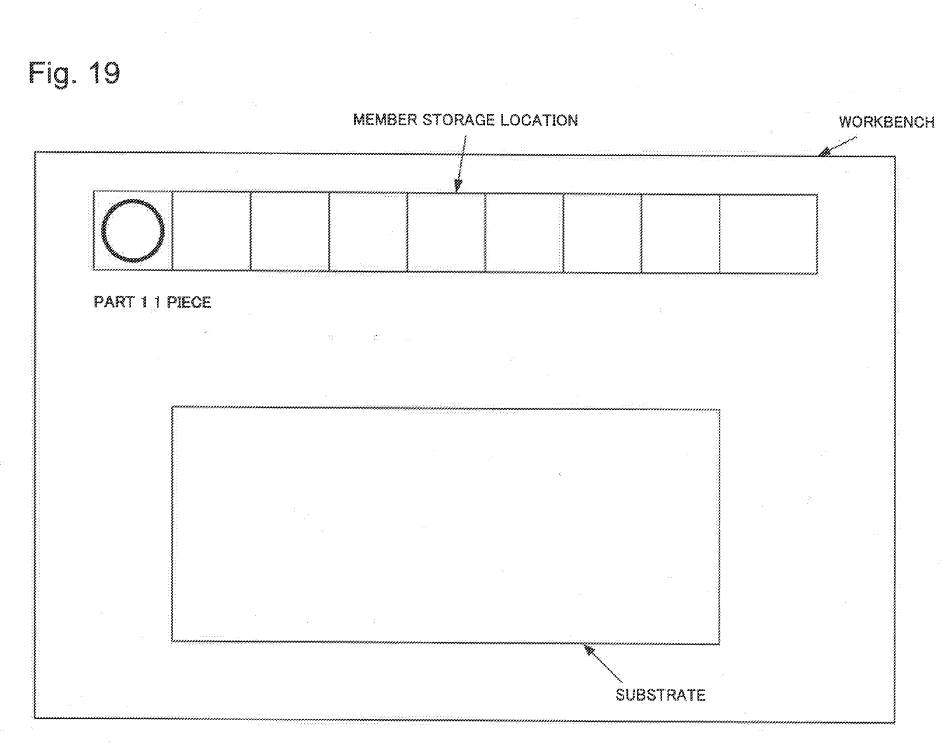

FIG. 19 illustrates an example of an indication display of takeout work of taking out one part 1. In the example in FIG. 19 and the like, for example, when a figure, a character string identifying a part, and the number of the part are displayed at a member placement location, the display is an indication display of takeout work of taking out the displayed number of parts identified by the character string from the location indicated by the figure. While the displayed figure is a circle in FIG. 19 and the like, the figure may be another figure such as a rectangle. A figure displayed as an indication display of takeout work may be determined on the basis of a form of a location where a part to be taken out is stored. As described above, an indication display does not necessarily need to be projected on a storage location of a member such as a part. For example, an indication display may be projected close to a storage location of a member such as a part.

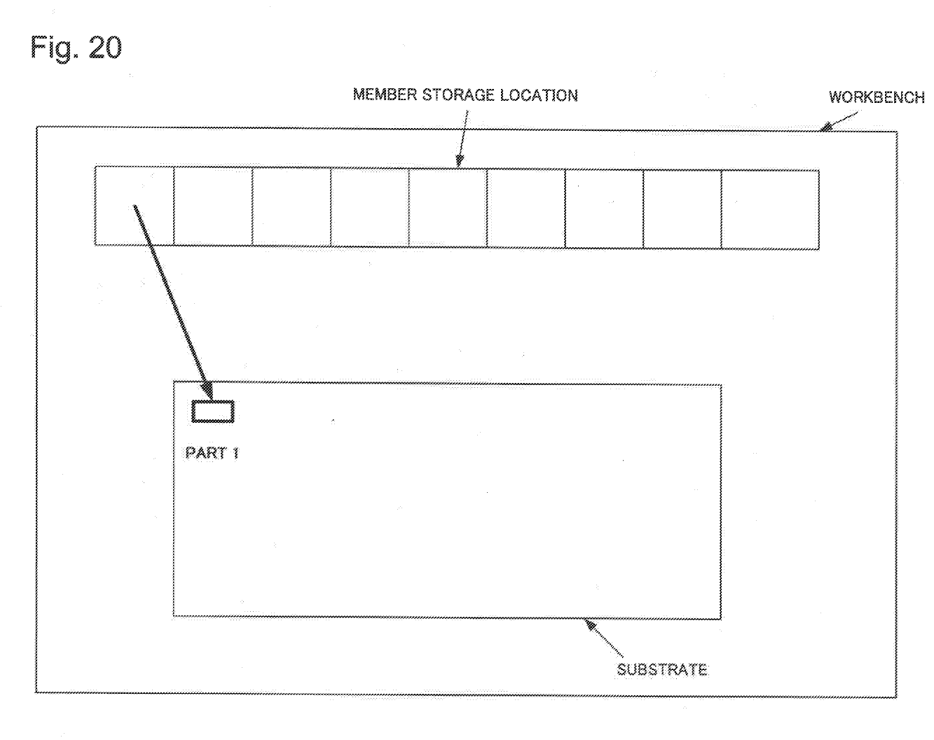

FIG. 20 illustrates an example of a guidance display and an indication display of mounting work of installing (i.e. mounting) a part 1 on the substrate. In the example illustrated in FIG. 20, an arrow is a guidance display. A rectangle and a character string “PART 1” is an indication display. In the example illustrated in FIG. 20, an indication display in an immediately preceding process (i.e. the indication display illustrated in FIG. 19) is cleared. As illustrated in FIG. 20, an indication display in a preceding process may be cleared. As illustrated in FIG. 20, a time period in which a guidance display and an indication display are both projected may exist. A guidance display may be projected first, and an indication display may be projected after the projection of the guidance display is completed.

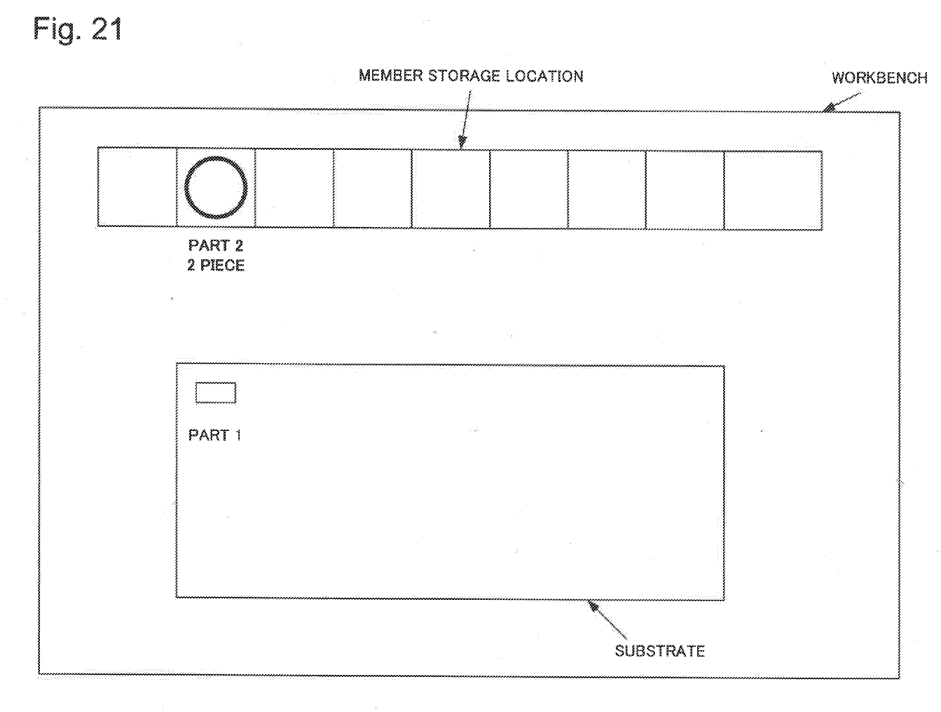

FIG. 21 illustrates an example of an indication display of takeout work of taking out two parts 2. As illustrated in FIG. 21, an indication display of takeout work of taking out a plurality of parts of an identical type may be indicated by, for example, an indication display indicating the number of the parts to be taken out.

An indication display in a preceding process may continue to be displayed in a less conspicuous manner than an indication display in a current process by changing at least either a color or brightness, and the like. In the example illustrated in FIG. 21, the indication display of the mounting work of mounting the part 1 continues to be displayed.

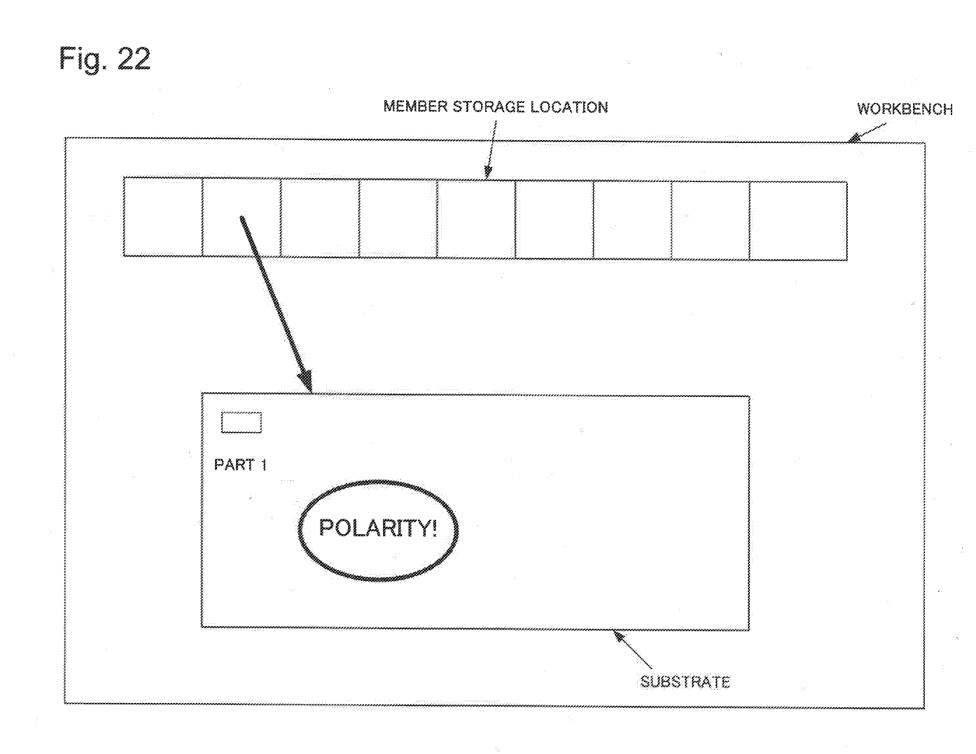

FIG. 22 illustrates an example of a guidance display and a caution display in mounting work of mounting a part 2. In FIG. 22, an arrow is a guidance display from a location where the part 2 is taken out according to the indication display illustrated in FIG. 21 to a location where the part taken out is mounted. An ellipse including a character string is a caution display. The character string included in the ellipse of the caution display indicates a caution.

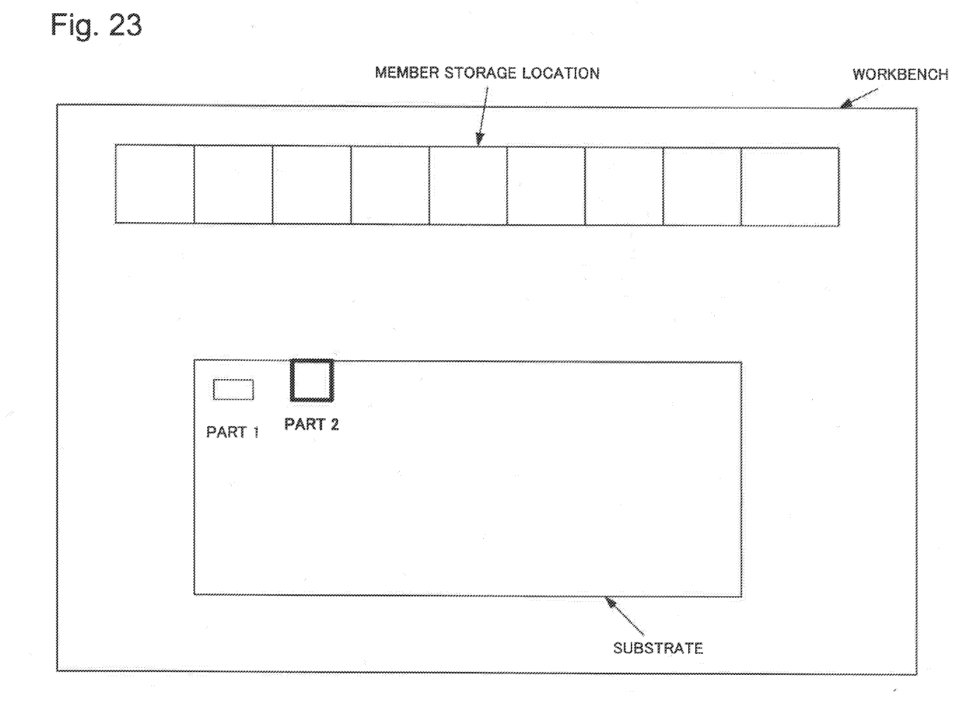

FIG. 23 illustrates an indication display of mounting work of mounting a first part 2 of the two parts 2 that are taken out.

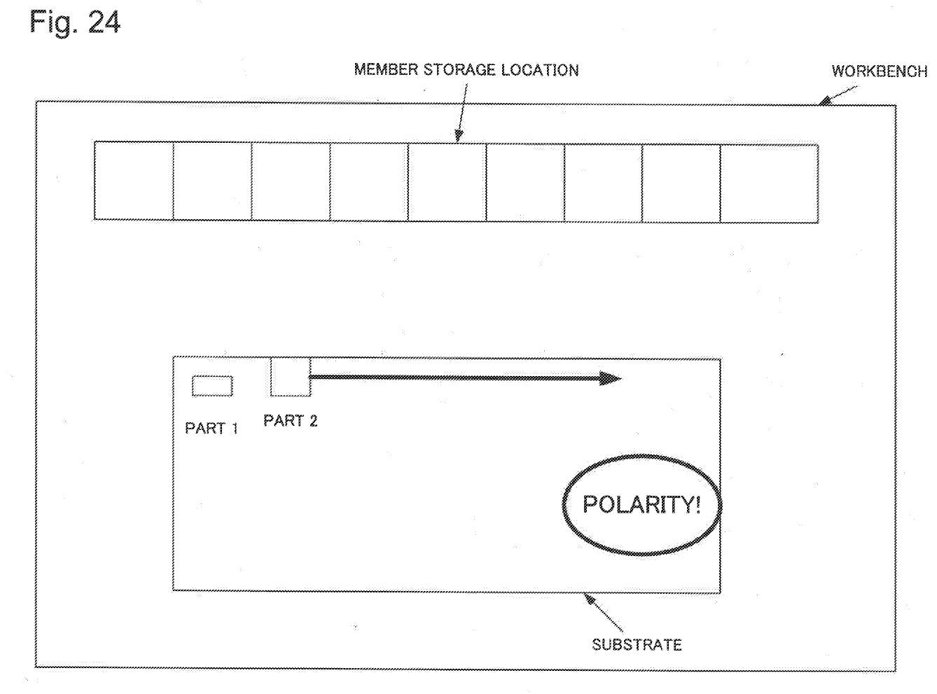

FIG. 24 illustrates an example of a guidance display and a caution display in mounting work of mounting a second part 2. As illustrated in the examples in FIGS. 22 and 24, a time period in which a guidance display and a caution display are both projected may exist. A guidance display may be projected first, and a caution display may be projected after the projection of the guidance display is completed.

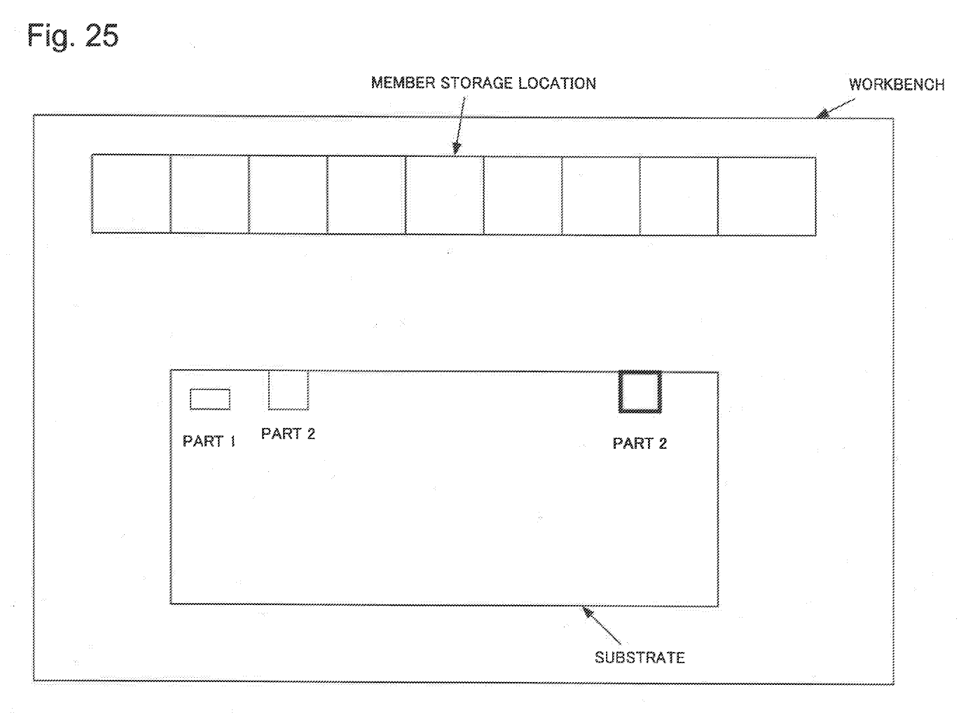

FIG. 25 illustrates an indication display of mounting work of mounting the second part 2 of the two parts 2 that are taken out.

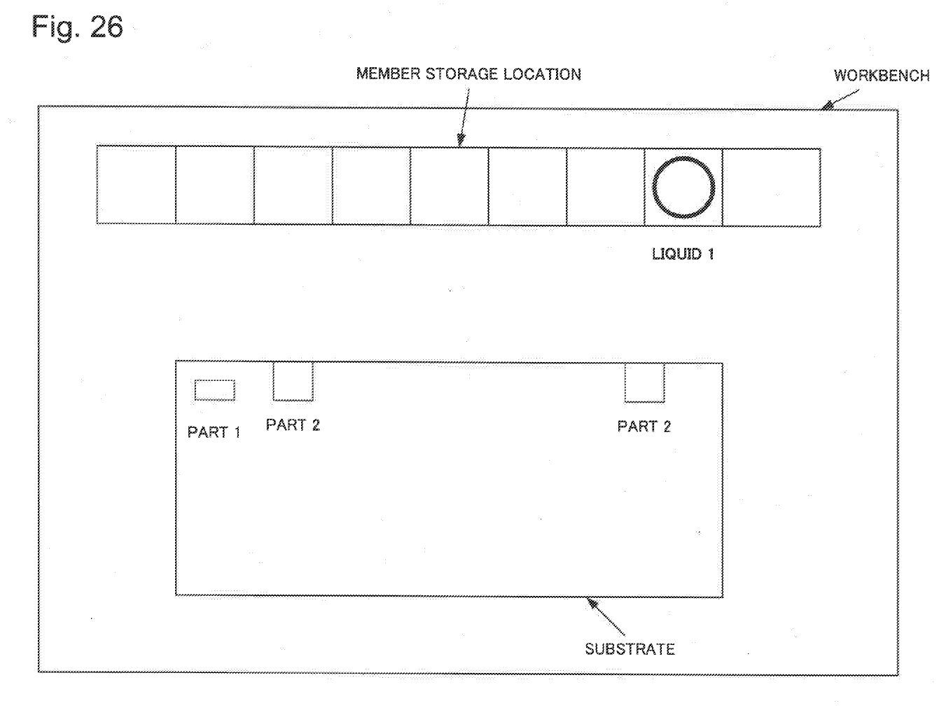

FIG. 26 illustrates an indication display of liquid takeout work of taking out a container of a liquid 1, such as an agent, applied to the substrate. FIG. 26 illustrates an example that the liquid 1 needs to be applied only to a location where a part 3, which is a next part to be mounted, is mounted.

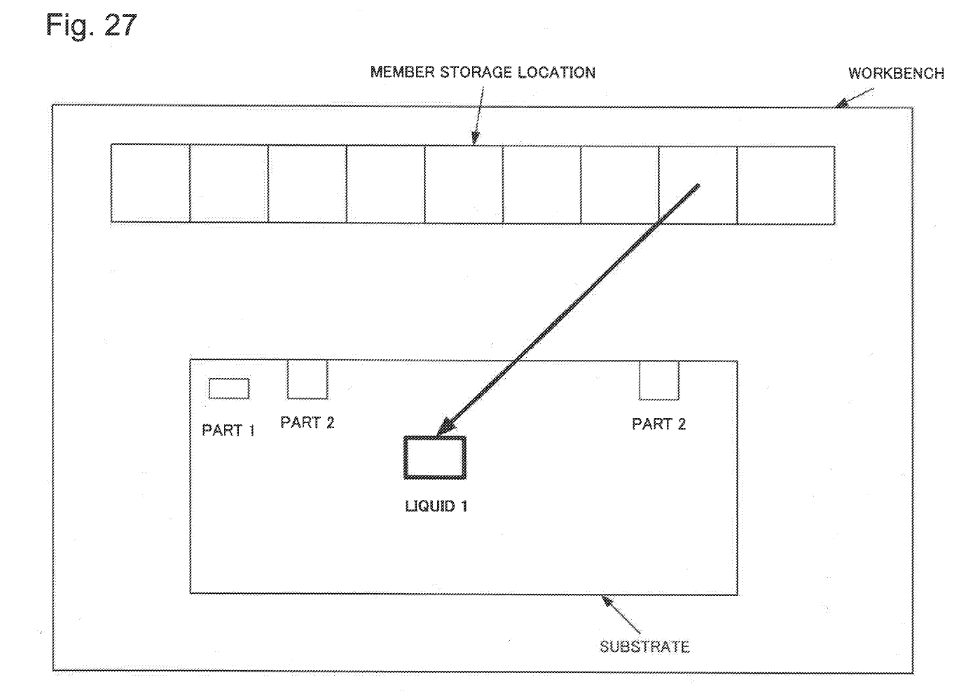

FIG. 27 illustrates a guidance display and an indication display of application work of applying the liquid 1. The guidance display is represented by an arrow. The indication display is represented by a character string “LIQUID 1” and a rectangle indicating a region to which the liquid 1 is applied. When the liquid 1 needs to be applied to a plurality of regions, the guidance display and the indication display as illustrated in FIG. 27 may be projected to the plurality of locations. When a liquid needs to be applied before a part is installed, displays as illustrated in drawings from FIG. 26 to FIG. 28, to be described next, may be provided after the indication display indicating an instruction to place the substrate, as illustrated in FIG. 18.

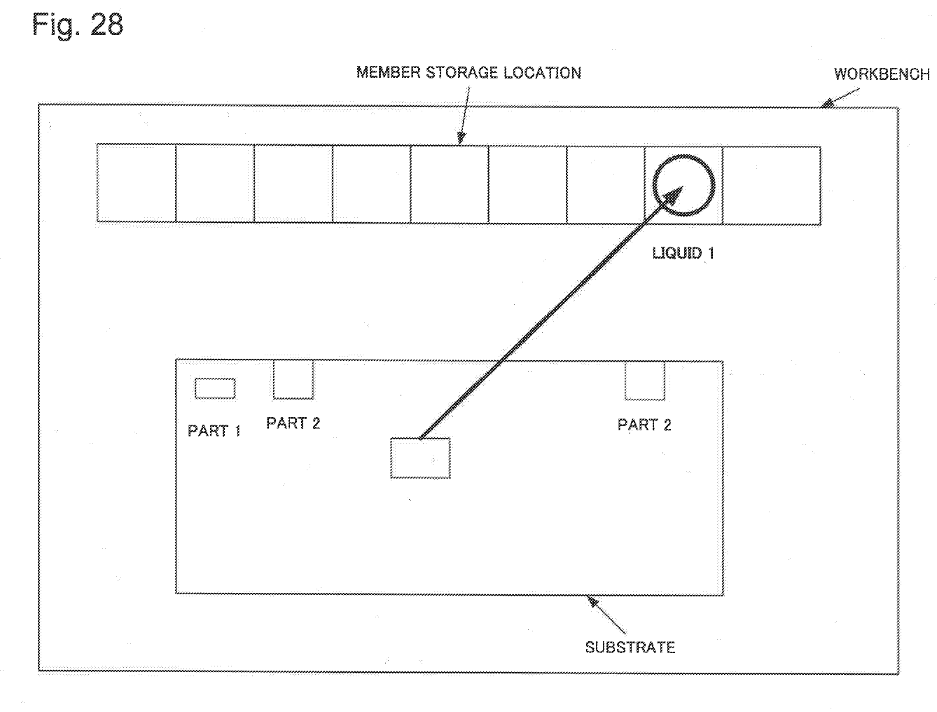

FIG. 28 illustrates a guidance display and an indication display of liquid storage work of storing a container of the liquid 1 at a location where the container is stored. In the example illustrated in FIG. 28, an arrow is the guidance display. The indication display is represented by a combination of a figure (a circle in the example in FIG. 28) and a character string. The indication display of the liquid storage work may be represented, for example, by a combination of a storage location of a container of a liquid taken out of a storage location, and a character string identifying the liquid.

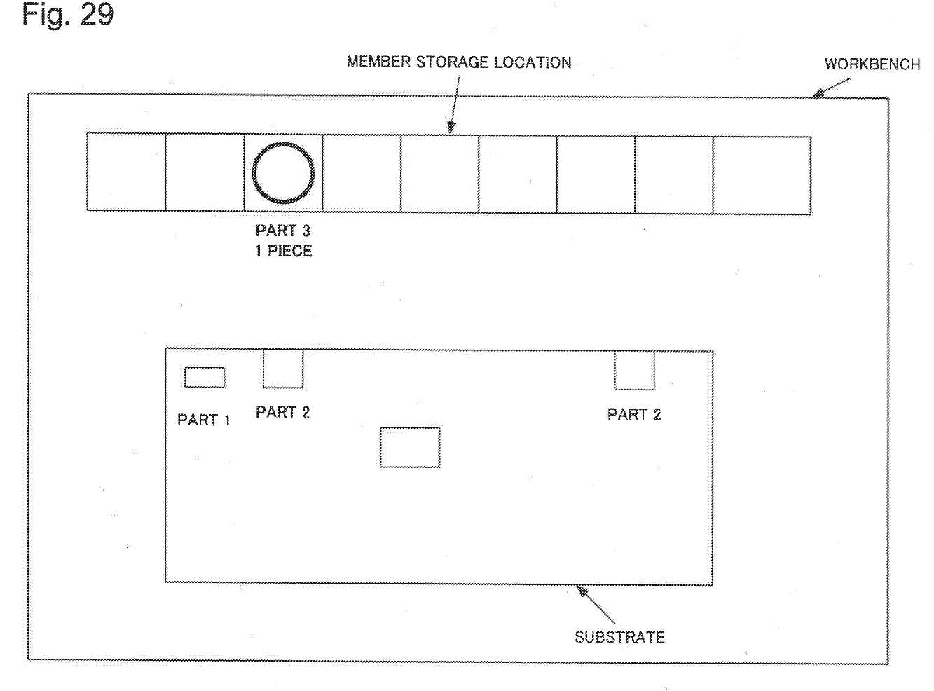

FIG. 29 illustrates an example of an indication display of takeout work of taking out one part 3.

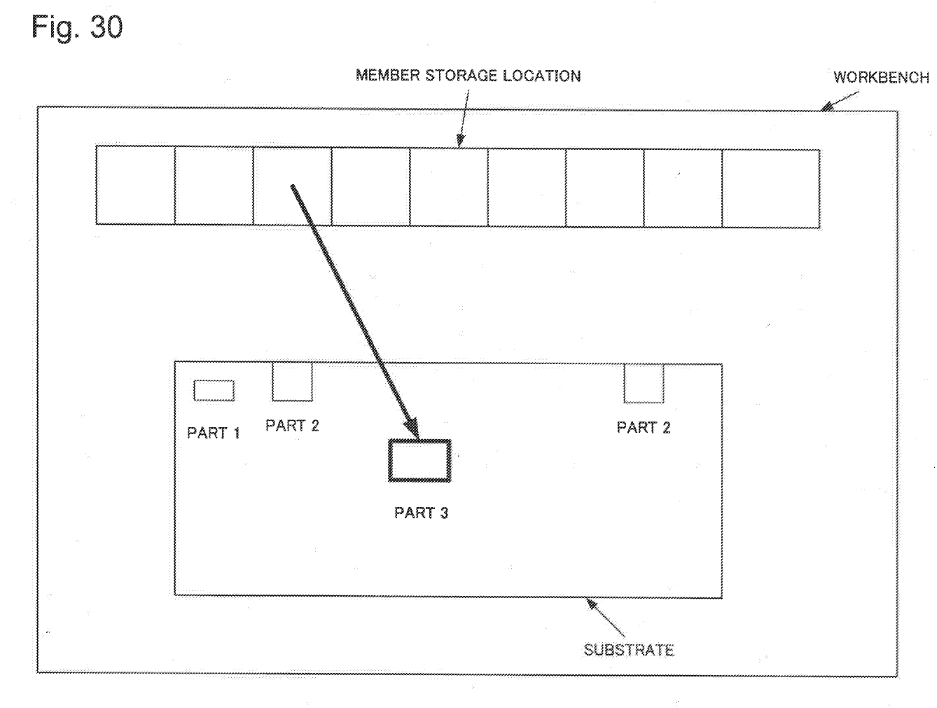

FIG. 30 illustrates a guidance display and an indication display of mounting work of mounting the part 3.

Work requiring use of a tool exists among types of work handling a part, such as mounting a part.

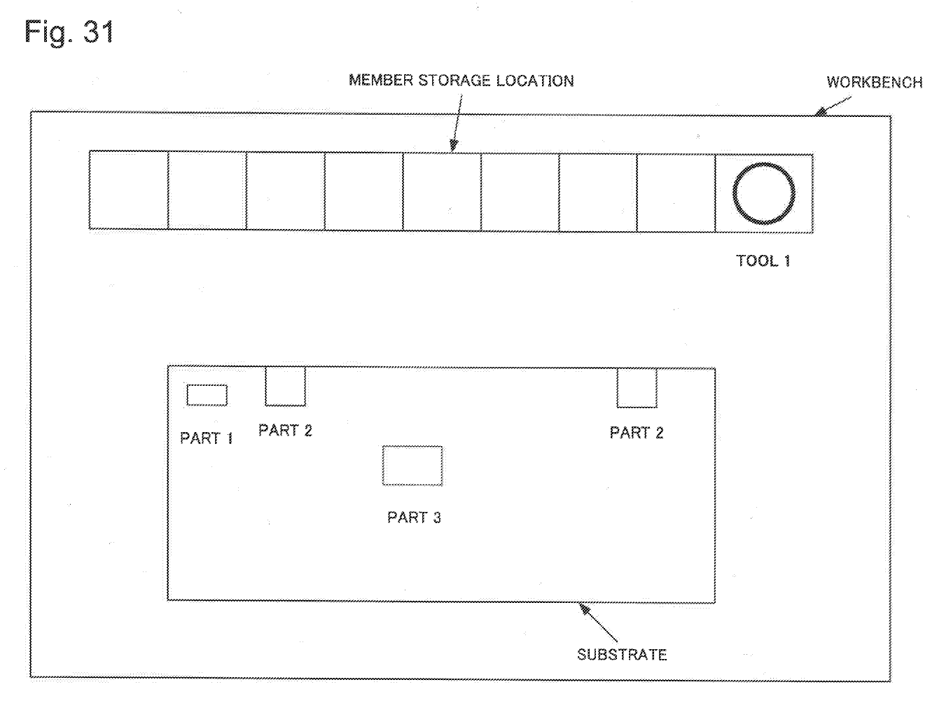

FIG. 31 illustrates an indication display of tool takeout work of taking out a tool 1 required for mounting a part 4, to be described later, on the substrate. The indication display of the tool takeout work may be represented by a character string identifying a tool (“TOOL 1” in the example in FIG. 31) and a figure indicating a location where the tool is stored (a circle in the example in FIG. 31).

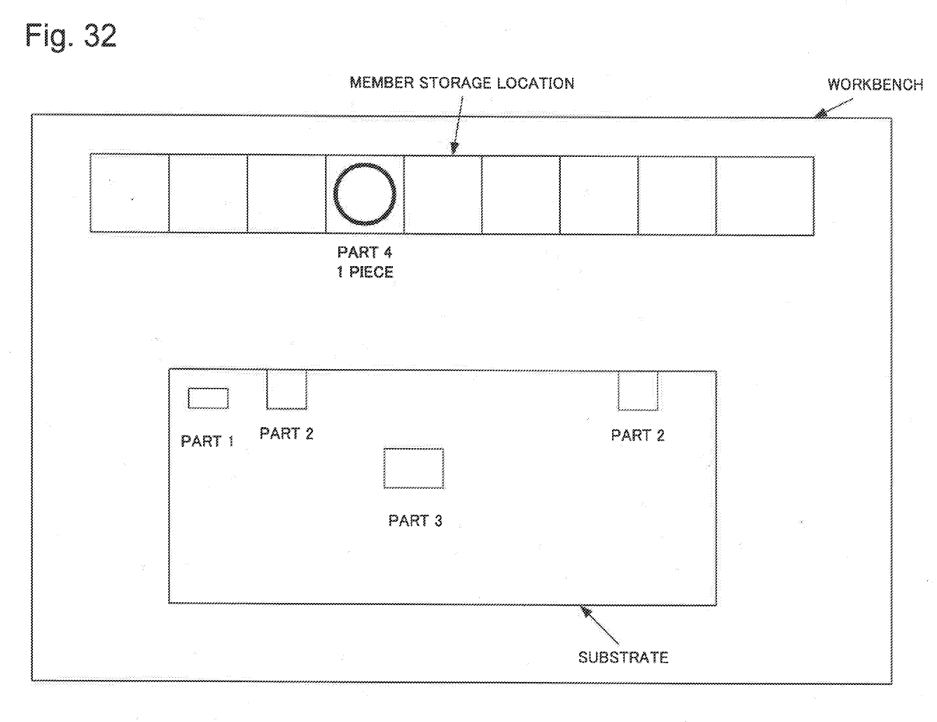

FIG. 32 illustrates an indication display of takeout work of taking out the part 4. As described above, the tool 1 is required for mounting the part 4 on the substrate.

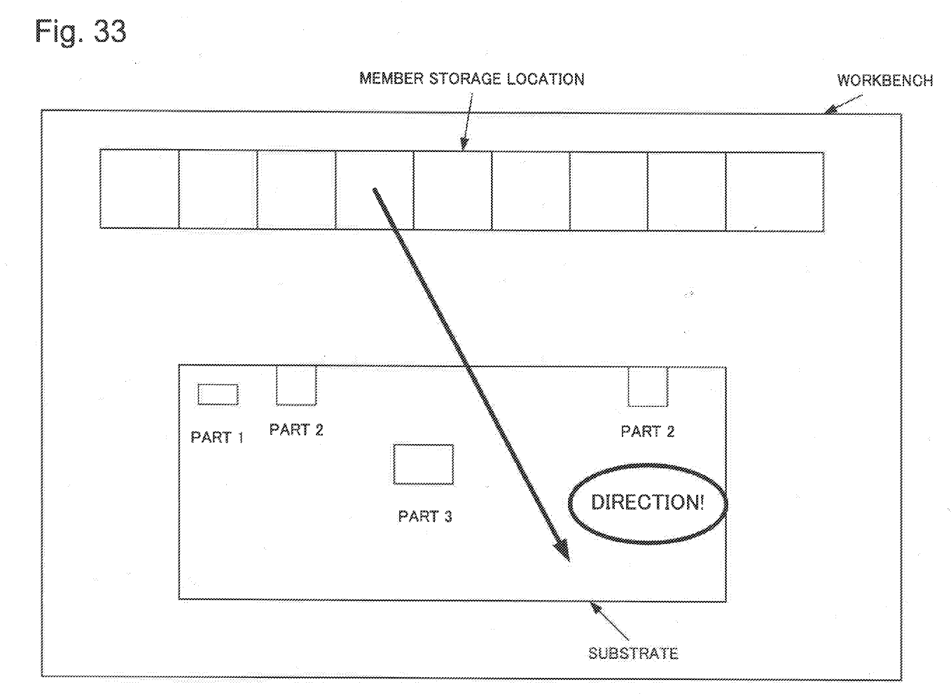

FIG. 33 illustrates a guidance display and a caution display of mounting work of mounting the part 4 on the substrate.

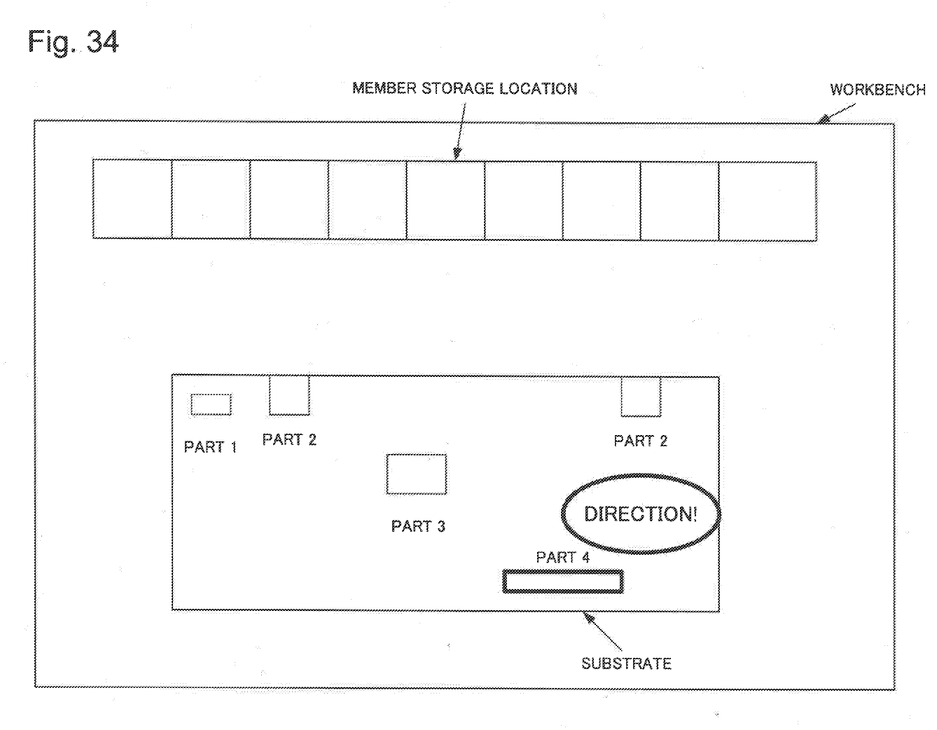

FIG. 34 illustrates a caution display and an indication display of the mounting work of mounting the part 4 on the substrate. As illustrated in FIG. 34, a time period in which the caution display and the indication display are both projected may exist. The caution display may be first projected, and the indication display may be projected after the projection of the caution display is completed. A frequency of mis-mounting of parts by the worker 3 can be reduced by projecting the indication display immediately after the projection of the caution display.

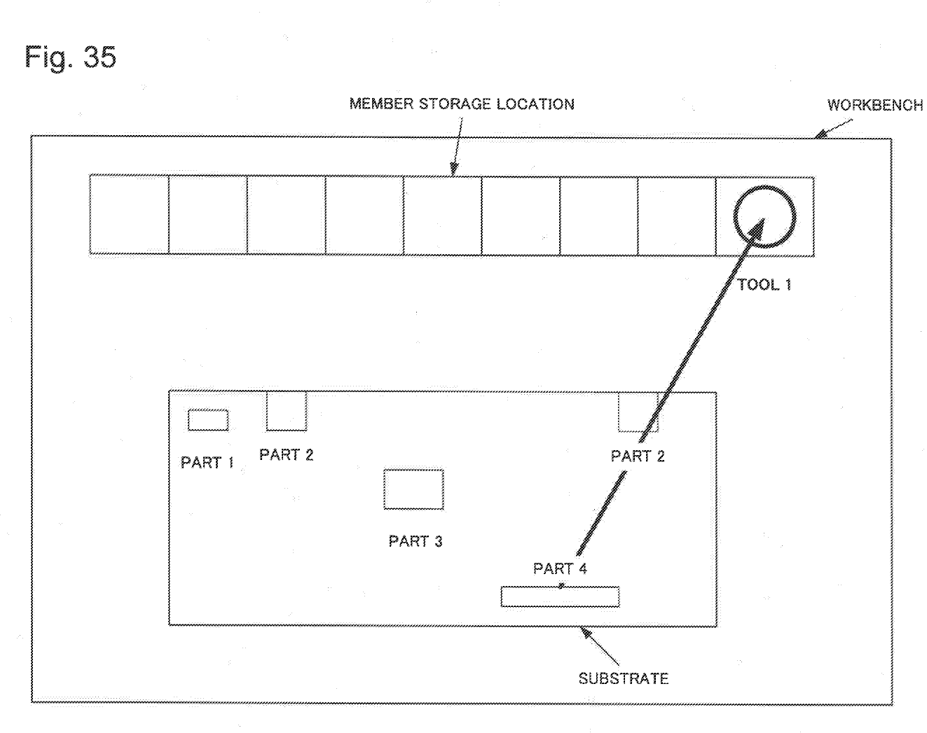

FIG. 35 illustrates a guidance display and an indication display of tool storage work of storing the tool 1 used for mounting the part 4 on the substrate at a location where the tool 1 is to be stored. In the example illustrated in FIG. 35, an arrow indicates the guidance display. As illustrated in FIG. 35, a guidance display may be projected in tool storage work of storing a tool following mounting work using the tool. An indication display of storing a tool may be represented by a character string identifying a tool which is taken out and a figure indicating a location where the tool is to be stored.

For example, an animation as exemplified in FIGS. 14 and 15 may be used in caution displays and indication displays in the examples illustrated in FIGS. 18 to 35. While guidance displays are projected in the examples illustrated in FIGS. 18 to 35, the guidance displays may not be projected.

The present example embodiment described above provides a first effect that working hours by a worker can be stably reduced.

The reason is that, the projection control unit 103 projects an indication display for a period of an indication display projection time that is a projection time predetermined for the indication display indicating work performed by a worker 3. By the worker 3 performing the work according to the projected indication display, the work is performed at a predetermined pace. Accordingly, working hours by the worker can be stably reduced.

The present example embodiment provides a second effect that working hours by a worker can be stably reduced on the basis of a skill level of the worker.

The reason is that the projection control unit 103 sets an indication display projection time on the basis of a skill level of a worker. Consequently, for example, an indication display projection time for displaying an indication display to a worker skilled in work may be shortened, and an indication display projection time for displaying the indication display to a worker unskilled in the work may be lengthened. Consequently, work is performed at a predetermined pace for each worker on the basis of a skill level of the worker. Accordingly, working hours by a worker can be stably reduced on the basis of a skill level of the worker.

### Second Example Embodiment

Next, a second example embodiment of the present invention will be described in detail with reference to drawings. The present example embodiment represents a basic configuration of the present invention.

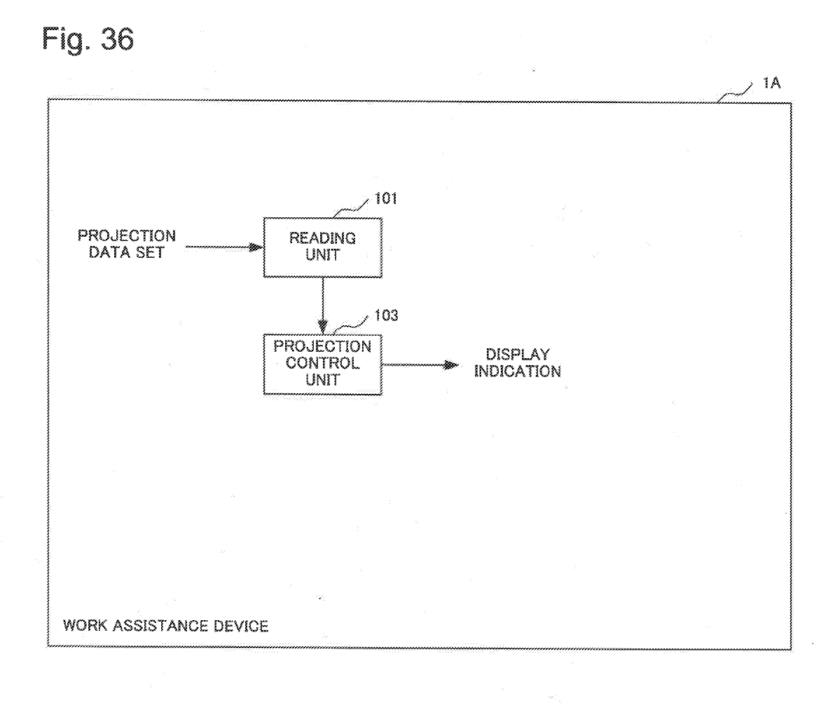

FIG. 36 is a block diagram illustrating a configuration example of a work assistance device 1A according to the present example embodiment.

Referring to FIG. 36, the work assistance device 1A includes a reading unit 101 and a projection control unit 103. The reading unit 101 sequentially reads a projection data set for each process according to a sequence number of process, from a work storage unit (unillustrated in FIG. 36). The work storage unit 102 stores a work procedure in which a projection data set is associated with a sequence number of process. The projection data set includes an indication display including a visual representation indicating, for each process of work performed by a worker, a position where work in a process is performed and a member handled in work in the process. The visual representation is a visually recognizable representation. The projection control unit 103 projects, by a projection unit (unillustrated in FIG. 36), the indication display included in the projection data set for a period of an indication display projection time that is a projection time predetermined for the indication display, upon readout of the projection data set.

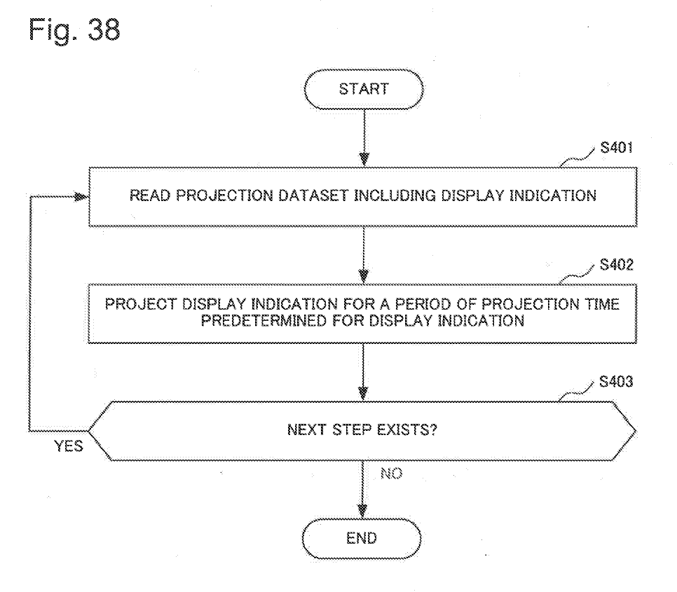

FIG. 38 is a flowchart illustrating an operation example of the work assistance device 1A according to the present example embodiment. Referring to FIG. 38, the reading unit 101 first reads a work procedure including an indication display for each process (Step S401). The reading unit 101 may read the work procedure from the work storage unit 102 storing the work procedure. Next, the projection control unit 103 projects an indication display included in the work procedure for a period of a projection time predetermined for the indication display (the indication display projection time described above) (Step S402). The projection control unit 103 may project the indication display by controlling the projection unit. When a next process exists (YES in Step S403), the work assistance device 1A repeats the operation from Step S401. When a next process does not exist (NO in Step S403), the work assistance device 1A ends the operation illustrated in FIG. 38.

The present example embodiment provides the same effect as the first effect according to the first example embodiment. The reason is the same as the reason the first effect according to the first example embodiment is provided.

### Other Example Embodiments

Each of the work assistance device 1 and the work assistance device 1A may be achieved with a computer including a processor, and a memory a program controlling the processor is loaded. The work assistance device 1 and the work assistance device 1A may also be achieved with dedicated hardware. The work assistance device 1 and the work assistance device 1A may also be achieved with a combination, with dedicated hardware, including a processor, and a memory in which a program controlling the processor is loaded.

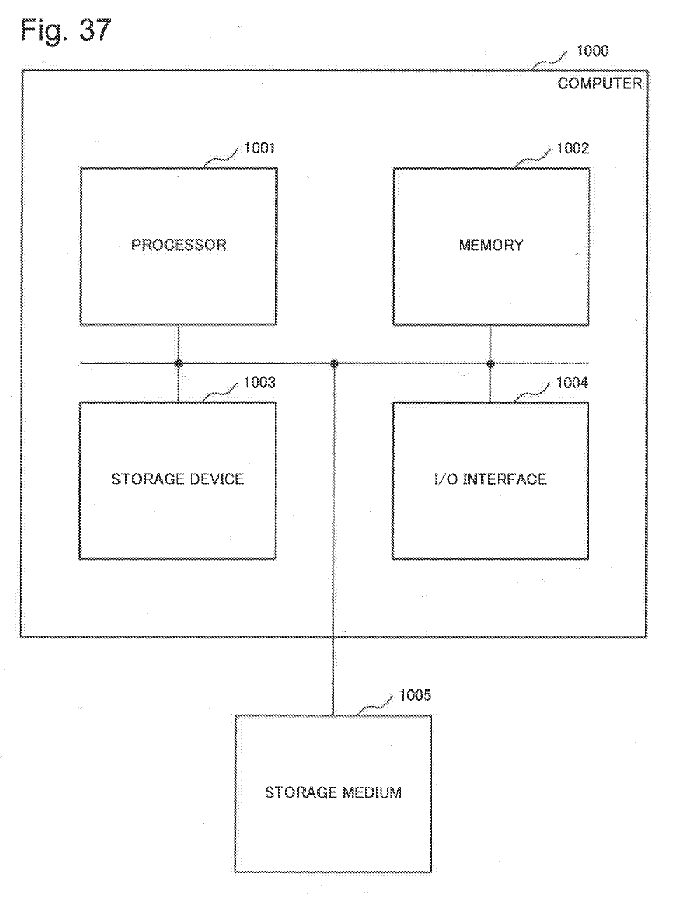

FIG. 37 is a diagram illustrating a hardware configuration example of a computer 1000 with which the work assistance device 1 or the work assistance device 1A is able to be achieved. Referring to FIG. 37, the computer 1000 includes a processor 1001, a memory 1002, a storage device 1003, and an input/output (I/O) interface 1004. The computer 1000 is able to access a storage medium 1005. For example, the memory 1002 and the storage device 1003 include storage devices such as a random access memory (RAM) and a hard disk. For example, the storage medium 1005 includes a storage device such as a RAM and a hard disk, a read only memory (ROM), and a portable storage medium. The storage device 1003 may be the storage medium 1005. The processor 1001 is able to read and write data and a program from and to the memory 1002 and the storage device 1003. The processor 1001 is able to access, for example, the projection unit 104 and the like through the I/O interface 1004. The processor 1001 is able to access the storage medium 1005. The storage medium 1005 stores a program that causes the computer 1000 to operate as the work assistance device 1 or the work assistance device 1A.

The processor 1001 loads, into the memory 1002, a program which is stored in the storage medium 1005 and causes the computer 1000 to operate as the work assistance device 1 or the work assistance device 1A. Then, by the processor 1001 executing the program loaded into the memory 1002, the computer 1000 operates as the work assistance device 1 or the work assistance device 1A.

Each unit included in a first list below may be achieved, for example, with a dedicated program which is loaded into the memory 1002 from the storage medium 1005 storing programs and is able to provide a function of each unit, and the processor 1001 which executes the program. The first list includes the reading unit 101, the projection control unit 103, the object identification unit 106, the worker identification unit 108, the instruction reception unit 111, the analysis unit 113, and the member detection unit 114. Each unit included in a second list below may be achieved with the memory 1002 and the storage device 1003 such as a hard disk device, each of which is included in the computer 1000. The second list includes the work storage unit 102, the skill level storage unit 107, and the history storage unit 112. Alternatively, each of the units included in the first list described above, each of the units included in the second list described above, and each of the units included in a third list described below may be achieved, in part or in whole, with dedicated circuits providing functions of the units. The third list includes the projection unit 104, the object information acquisition unit 105, the worker information acquisition unit 109, the input unit 110, and the imaging unit 115.

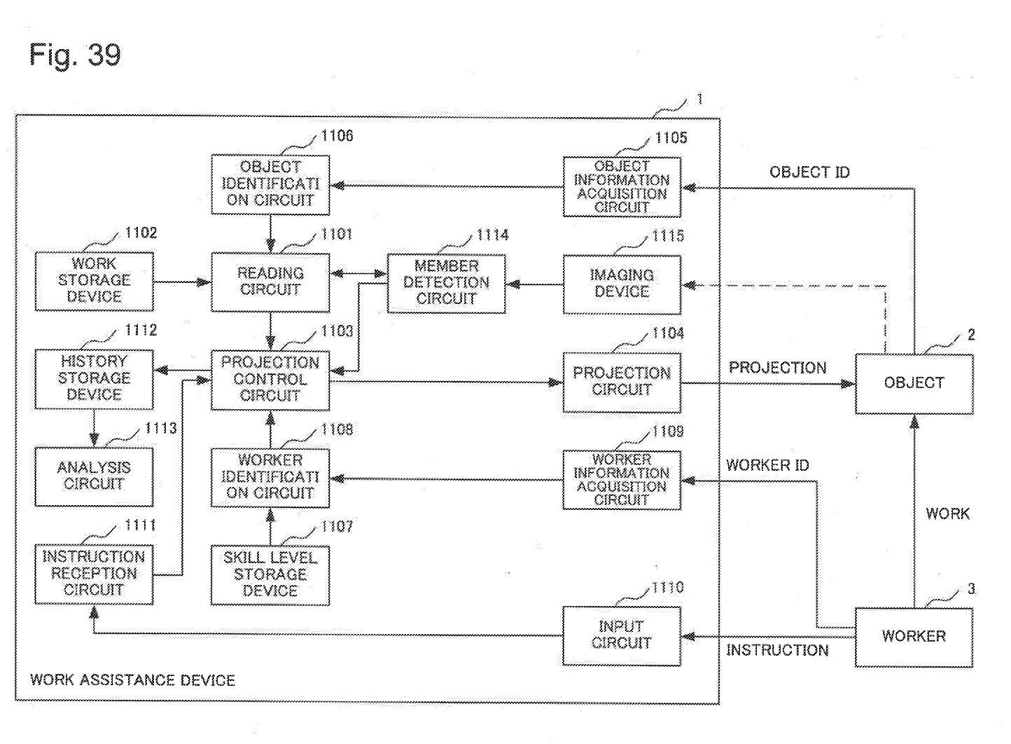

FIG. 39 is a block diagram illustrating a configuration example of the work assistance device 1 according to the first example embodiment, which is provided by a circuit. In the configuration example illustrated in FIG. 39, the work assistance device 1 includes a reading circuit 1101, a work storage device 1102, a projection control circuit 1103, a projection circuit 1104, an object information acquisition circuit 1105, an object identification circuit 1106, and a skill level storage device 1107. The work assistance device 1 further includes a worker identification circuit 1108, a worker information acquisition circuit 1109, an input circuit 1110, an instruction reception circuit 1111, a history storage device 1112, an analysis circuit 1113, a member detection circuit 1114, and an imaging device 1115.

The work storage device 1102, the skill level storage device 1107, and the history storage device 1112 may be achieved with a circuit. The work storage device 1102, the skill level storage device 1107, and the history storage device 1112 may be achieved with a storage device such as a hard disk and a solid state drive (SSD). For example, the imaging device 1115 is a camera outputting image data of a captured image.

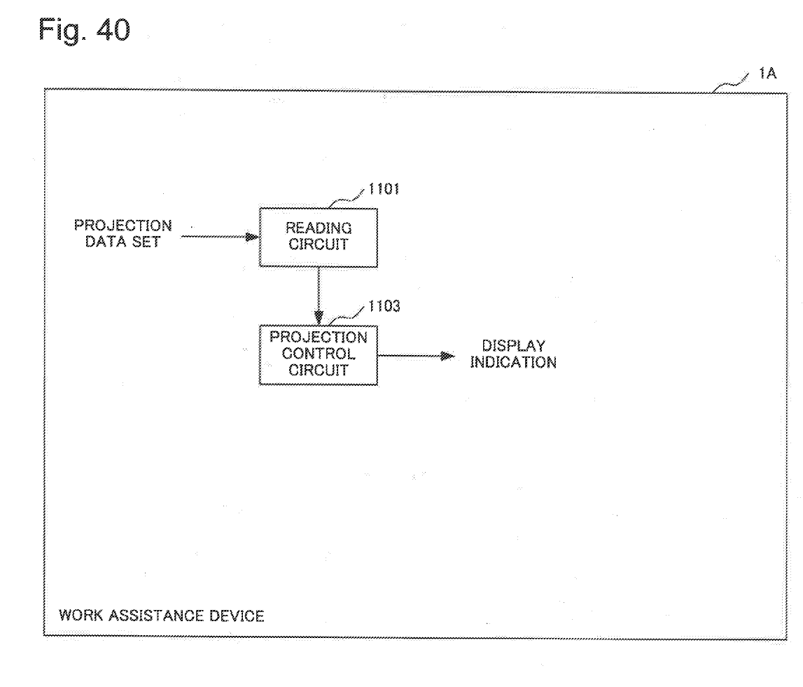

FIG. 40 is a block diagram illustrating a configuration example of the work assistance device 1A according to the second example embodiment, which is achieved with a circuit. In the example illustrated in FIG. 40, the work assistance device 1A includes a reading circuit 1101 and a projection control circuit 1103.

The reading circuit 1101 operates as the reading unit 101. The work storage device 1102 operates as the work storage unit 102. The projection control circuit 1103 operates as the projection control unit 103. The projection circuit 1104 operates as the projection unit 104. The object information acquisition circuit 1105 operates as the object information acquisition unit 105. The object identification circuit 1106 operates as the object identification unit 106. The skill level storage device 1107 operates as the skill level storage unit 107. The worker identification circuit 1108 operates as the worker identification unit 108. The worker information acquisition circuit 1109 operates as the worker information acquisition unit 109. The input circuit 1110 operates as the input unit 110. The instruction reception circuit 1111 operates as the instruction reception unit 111. The history storage device 1112 operates as the history storage unit 112. The analysis circuit 1113 operates as the analysis unit 113. The member detection circuit 1114 operates as the member detection unit 114. The imaging device 1115 operates as the imaging unit 115.

In other words, the reading unit 101 is achieved by the reading circuit 1101. The work storage unit 102 is achieved by the work storage device 1102. The projection control unit 103 is achieved by the projection control circuit 1103. The projection unit 104 is achieved by the projection circuit 1104. The object information acquisition unit 105 is achieved by the object information acquisition circuit 1105. The object identification unit 106 is achieved by the object identification circuit 1106. The skill level storage unit 107 is achieved by the skill level storage device 1107. The worker identification unit 108 is achieved by the worker identification circuit 1108. The worker information acquisition unit 109 is achieved by the worker information acquisition circuit 1109. The input unit 110 is achieved by the input circuit 1110. The instruction reception unit 111 is achieved by the instruction reception circuit 1111. The history storage unit 112 is achieved by the history storage device 1112. The analysis unit 113 is achieved by the analysis circuit 1113. The member detection unit 114 is achieved by the member detection circuit 1114. The imaging unit 115 is achieved by the imaging device 1115.

The above-described example embodiments may also be described in part or in whole as the following Supplementary Notes but are not limited thereto.

### (Supplementary Note 1)

A work assistance device comprising:

reading means for sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and

projection control means for projecting, by projection means, the indication display included in the projection data set, upon readout of the projection data set, for a period of an indication display projection time being a projection time determined for the indication display.

### (Supplementary Note 2)

The work assistance device according to Supplementary Note 1, wherein

the projection data set further includes a caution display including the visual representation indicating a caution in the work, and

the projection control means projects the caution display before projecting the indication display when the read projection data set includes the caution display.

### (Supplementary Note 3)

The work assistance device according to Supplementary Note 1 or 2, wherein

the projection data set of a second process further includes a guidance display including the visual representation representing guidance from a position where work in a first process is performed to a position where work in the second process is performed, the first process and the second process being two consecutive processes in which a same member is handled, the second process following the first process, and

the projection control means projects the guidance display when the read projection data set includes the guidance display.

### (Supplementary Note 4)

The work assistance device according to any one of Supplementary Notes 1 to 3, wherein

the visual representation includes a representation by an animation.

### (Supplementary Note 5)

The work assistance device according to any one of Supplementary Notes 1 to 4, wherein

the projection data set further includes the indication display projection time, and

the projection control means projects the indication display for a period of the indication display projection time included in the read projection data set.

### (Supplementary Note 6)

The work assistance device according to any one of Supplementary Notes 1 to 5, further comprising:

skill level storage means for storing a skill level related to the work for each of the worker; and

worker identification means for acquiring an identifier of the worker, wherein

the projection control means reads the skill level of the worker the identifier of whom is acquired, updates the indication display projection time based on the read skill level, and projects the indication display for a period of the updated indication display projection time.

### (Supplementary Note 7)

The work assistance device according to any one of Supplementary Notes 1 to 6, wherein

the work procedure includes the projection data set of a mounting process being the process of performing work of equipping a part as the member on a substrate, and

the projection data set of the mounting process includes a position on the substrate where the part is equipped, as a position where the work is performed, and includes, as the indication display, a display indicating a location where the part is equipped and a symbol indicating the part.

### (Supplementary Note 8)

The work assistance device according to Supplementary Note 7, wherein

the work procedure includes the projection data set of a part takeout process being the process of performing work of taking out the part from a location where the part is stored, and

the projection data set of the part takeout process includes, as a position where the work is performed, a position of a location where the part is stored, and includes, as the indication display, a display indicating a location where the part is stored, a symbol indicating the part, and a quantity of the part.

### (Supplementary Note 9)

The work assistance device according to Supplementary Note 7 or 8, wherein

the work procedure includes the projection data set of a liquid takeout process and the projection data set of an application process, the liquid takeout process being the process of performing work of taking out a liquid as the member from a location where the liquid is stored, the liquid being applied to the substrate, the application process being the process of performing work of applying the liquid to the substrate,

the projection data set of the liquid takeout process includes, as a position where the work is performed, a position of a location where the liquid is stored, and includes, as the indication display, a display indicating a location where the liquid is stored and a symbol indicating the liquid, and

the projection data set of the application process includes, as a position where the work is performed, a location where the liquid is applied, and includes, as the indication display, a display indicating a position of a location where the liquid is applied and a symbol indicating the liquid.

### (Supplementary Note 10)

The work assistance device according to Supplementary Note 7 or 8, wherein

the work procedure includes the projection data set of a tool takeout process and the projection data set of a tool storage process, the tool takeout process being the process of performing work of taking out a tool as the member from a location where the tool is stored, the tool being used in the succeeding work, the tool storage process being the process of performing work of storing the tool at a location where the tool is to be stored,

the projection data set of the tool takeout process includes a location where the tool is stored, as a position where the work is performed, and includes, as the indication display, a display indicating a location where the tool is stored, a symbol indicating the tool, and a display indicating take out of the tool, and

the projection data set of the tool storage process includes, as a position where the work is performed, a location where the tool is to be stored, and includes, as the indication display, a display indicating a location where the tool is to be stored, a symbol indicating the tool, and a display indicating storage of the tool.

### (Supplementary Note 11)

The work assistance device according to any one of Supplementary Notes 7 to 10, wherein

the work storage means stores the work procedure for each type of the substrate,

the work assistance device further comprises:

type acquisition means for acquiring a type of the substrate; and

the reading means sequentially reads the projection data set included in the work procedure for an acquired type of the substrate.

### (Supplementary Note 12)

The work assistance device according to any one of Supplementary Notes 1 to 11, further comprising:

instruction reception means for receiving a control instruction being an instruction by the worker for controlling progression of the projection, wherein

the projection control means stores process identification information in history storage means when receiving a predetermined type of the control instruction, the process identification information identifying the process in which the indication display is projected when the work indication is performed, and

the work assistance device further comprises

analysis means for analyzing a frequency of performing the control instruction based on the process identification information stored in the history storage means.

### (Supplementary Note 13)

A work assistance system including the work assistance device according to any one of Supplementary Notes 1 to 12, comprising:

the projection means.

### (Supplementary Note 14)

A work assistance method comprising:

sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and

projecting, by projection means, the indication display included in the projection data set, upon readout of the projection data set, for a period of an indication display projection time being a projection time determined for the indication display.

### (Supplementary Note 15)

The work assistance method according to Supplementary Note 14, wherein

the work procedure includes the projection data set further including a caution display including the visual representation indicating a caution in the work, and

the method comprises projecting the caution display before the indication display is projected when the read projection data set includes the caution display.

### (Supplementary Note 16)

The work assistance method according to Supplementary Note 14 or 15, wherein

the work procedure includes the projection data set of work in a second process, the projection data set further including a guidance display including the visual representation representing guidance from a position where work in a first process is performed to a position where work in the second process is performed, the first process and the second process being two consecutive processes in which a same member is handled, the second process following the first process, and

the method comprises projecting the guidance display when the read projection data set includes the guidance display.

### (Supplementary Note 17)

The work assistance method according to any one of Supplementary Notes 14 to 16, wherein

the visual representation includes a representation by an animation.

### (Supplementary Note 18)

The work assistance method according to any one of Supplementary Notes 14 to 17, wherein

the projection data set further includes the indication display projection time, and the method comprises:

projecting the indication display for a period of the indication display projection time included in the read projection data set.

### (Supplementary Note 19)

The work assistance method according to any one of Supplementary Notes 14 to 18, further comprising:

acquiring an identifier of the worker; and

reading, from skill level storage means storing a skill level related to the work for each of the worker, the skill level of the worker the identifier of whom is acquired, updating the indication display projection time based on the read skill level, and projecting the indication display for a period of the updated indication display projection time.

### (Supplementary Note 20)

The work assistance method according to any one of Supplementary Notes 14 to 19, wherein

the work procedure includes the projection data set of a mounting process being the process of performing work of equipping a part as the member on a substrate, and

the projection data set of the mounting process includes a position on the substrate where the part is equipped, as a position where the work is performed, and includes, as the indication display, a display indicating a location where the part is equipped and a symbol indicating the part.

### (Supplementary Note 21)

The work assistance method according to Supplementary Note 20, wherein

the work procedure includes the projection data set of a part takeout process being the process of performing work of taking out the part from a location where the part is stored, and

the projection data set of the part takeout process includes, as a position where the work is performed, a position of a location where the part is stored, and includes, as the indication display, a display indicating a location where the part is stored, a symbol indicating the part, and a quantity of the part.

### (Supplementary Note 22)

The work assistance method according to Supplementary Note 20 or 21, wherein

the work procedure includes the projection data set of a liquid takeout process and the projection data set of an application process, the liquid takeout process being the process of performing work of taking out a liquid as the member from a location where the liquid is stored, the liquid being applied to the substrate, the application process being the process of performing work of applying the liquid to the substrate,

the projection data set of the liquid takeout process includes, as a position where the work is performed, a position of a location where the liquid is stored, and includes, as the indication display, a display indicating a location where the liquid is stored and a symbol indicating the liquid, and

the projection data set of the application process includes, as a position where the work is performed, a location where the liquid is applied, and includes, as the indication display, a display indicating a position of a location where the liquid is applied and a symbol indicating the liquid.

### (Supplementary Note 23)

The work assistance method according to Supplementary Note 20 or 21, wherein

the work procedure includes the projection data set of a tool takeout process and the projection data set of a tool storage process, the tool takeout process being the process of performing work of taking out a tool as the member from a location where the tool is stored, the tool being used in the succeeding work, the tool storage process being the process of performing work of storing the tool at a location where the tool is to be stored,

the projection data set of the tool takeout process includes a location where the tool is stored, as a position where the work is performed, and includes, as the indication display, a display indicating a location where the tool is stored, a symbol indicating the tool, and a display indicating take out of the tool, and

the projection data set of the tool storage process includes, as a position where the work is performed, a location where the tool is to be stored, and includes, as the indication display, a display indicating a location where the tool is to be stored, a symbol indicating the tool, and a display indicating storage of the tool.

### (Supplementary Note 24)

The work assistance method according to any one of Supplementary Notes 20 to 23, wherein

the work storage means stores the work procedure for each type of the substrate, and the method further comprises:

acquiring a type of the substrate; and

reading sequentially the projection data set included in the work procedure for an acquired type of the substrate.

### (Supplementary Note 25)

The work assistance method according to any one of Supplementary Notes 14 to 24, further comprising:

receiving a control instruction being an instruction by the worker for controlling progression of the projection, wherein

the projection control means stores process identification information in history storage means when receiving a predetermined type of the control instruction, the process identification information identifying the process in which the indication display is projected when the work indication is performed, and the method further comprises:

analyzing a frequency of performing the control instruction based on the process identification information stored in the history storage means.

### (Supplementary Note 26)

A work assistance program causing a computer to perform:

reading processing of sequentially reading a projection data set for each process, according to a sequence number of the process, from work storage means for storing a work procedure in which the projection data set is associated with a sequence number of the process, the projection data set including an indication display including a visually recognizable visual representation indicating, for each process of work performed by a worker, a position where work in a process is performed and a member handled in work in the process; and

projection control processing of projecting, by projection means, the indication display included in the projection data set, upon readout of the projection data set, for a period of an indication display projection time being a projection time determined for the indication display.

### (Supplementary Note 27)

The work assistance program according to Supplementary Note 14, wherein

the work procedure includes the projection data set further including a caution display including the visual representation indicating a caution in the work, and

the projection control processing projects the caution display before projecting the indication display when the read projection data set includes the caution display.

### (Supplementary Note 28)

The work assistance program according to Supplementary Note 14 or 15, wherein

the projection data set of a second process further includes a guidance display including the visual representation representing guidance from a position where work in a first process is performed to a position where work in a second process is performed, the first process and the second process being two consecutive processes in which a same member is handled, the second process following the first process, and

the projection control processing projects the guidance display when the read projection data set includes the guidance display.

### (Supplementary Note 29)

The work assistance program according to any one of Supplementary Notes 26 to 28, wherein

the visual representation includes a representation by an animation.

### (Supplementary Note 30)

The work assistance program according to any one of Supplementary Notes 26 to 29, wherein

the projection data set further includes the indication display projection time, and

the projection control processing projects the indication display for a period of the indication display projection time included in the read projection data set.

### (Supplementary Note 31)

The work assistance program according to any one of Supplementary Notes 26 to 30, causing a computer to execute:

worker identification processing of acquiring an identifier of the worker, wherein

the projection control processing reads, from skill level storage means, the skill level of the worker the identifier of whom is acquired, updates the indication display projection time based on the read skill level, and projects the indication display for a period of the updated indication display projection time, the skill level storage means storing a skill level related to the work for each of the worker.

### (Supplementary Note 32)

The work assistance program according to any one of Supplementary Notes 26 to 31, wherein

the work procedure includes the projection data set of a mounting process being the process of performing work of equipping a part as the member on a substrate, and

the projection data set of the mounting process includes a position on the substrate where the part is equipped, as a position where the work is performed, and includes, as the indication display, a display indicating a location where the part is equipped and a symbol indicating the part.

### (Supplementary Note 33)

The work assistance program according to Supplementary Note 32, wherein

the work procedure includes the projection data set of a part takeout process being the process of performing work of taking out the part from a location where the part is stored, and

the projection data set of the part takeout process includes, as a position where the work is performed, a position of a location where the part is stored, and includes, as the indication display, a display indicating a location where the part is stored, a symbol indicating the part, and a quantity of the part.

### (Supplementary Note 34)

The work assistance program according to Supplementary Note 32 or 33, wherein

the work procedure includes the projection data set of a liquid takeout process and the projection data set of an application process, the liquid takeout process being the process of performing work of taking out a liquid as the member from a location where the liquid is stored, the liquid being applied to the substrate, the application process being the process of performing work of applying the liquid to the substrate,

the projection data set of the liquid takeout process includes, as a position where the work is performed, a position of a location where the liquid is stored, and includes, as the indication display, a display indicating a location where the liquid is stored and a symbol indicating the liquid, and

the projection data set of the application process includes, as a position where the work is performed, a location where the liquid is applied, and includes, as the indication display, a display indicating a position of a location where the liquid is applied and a symbol indicating the liquid.

### (Supplementary Note 35)

The work assistance program according to Supplementary Note 32 or 33, wherein

the work procedure includes the projection data set of a tool takeout process and the projection data set of a tool storage process, the tool takeout process being the process of performing work of taking out a tool as the member from a location where the tool is stored, the tool being used in the succeeding work, the tool storage process being the process of performing work of storing the tool at a location where the tool is to be stored,

the projection data set of the tool takeout process includes a location where the tool is stored, as a position where the work is performed, and includes, as the indication display, a display indicating a location where the tool is stored, a symbol indicating the tool, and a display indicating take out of the tool, and

the projection data set of the tool storage process includes, as a position where the work is performed, a location where the tool is to be stored, and includes, as the indication display, a display indicating a location where the tool is to be stored, a symbol indicating the tool, and a display indicating storage of the tool.

### (Supplementary Note 36)

The work assistance program according to any one of Supplementary Notes 32 to 35, further causing a computer to execute:

the work storage means stores the work procedure for each type of the substrate,

type acquisition processing of acquiring a type of the substrate, wherein

the work storage means stores the work procedure for each type of the substrate, and

the reading processing sequentially reads the projection data set included in the work procedure for an acquired type of the substrate.

### (Supplementary Note 37)

The work assistance program according to any one of Supplementary Notes 26 to 36, further causing a computer to execute:

instruction reception processing of receiving a control instruction being an instruction by the worker for controlling progression of the projection, wherein

the projection control processing stores process identification information in history storage means when receiving a predetermined type of the control instruction, the process identification information identifying the process in which the indication display is projected when the work indication is performed, and

the work assistance program further causes a computer to execute:

analysis processing of analyzing a frequency of performing the control instruction based on the process identification information stored in the history storage means.

### (Supplementary Note 38)

A non-transitory computer readable storage medium storing the work assistance program according to any one of Supplementary Notes 26 to 38.

While the present invention has been described above with reference to the example embodiments, the present invention is not limited to the aforementioned example embodiments. Various changes and modifications that can be understood by a person skilled in the art may be made to the configurations and details of the present invention, within the scope of the present invention.

This application claims priority based on Japanese Patent Application No. 2015-027785 filed on Feb. 16, 2015, the disclosure of which is hereby incorporated by reference thereto in its entirety.

### REFERENCE SIGNS LIST

1 Work assistance device
1A Work assistance device
2 Object
3 Worker
4 Workbench
5 Fixing unit
6 Signal line
7 Signal line
8 Signal line
101 Reading unit
102 Work storage unit
103 Projection control unit
104 Projection unit
105 Object information acquisition unit
106 Object identification unit
107 Skill level storage unit
108 Worker identification unit
109 Worker information acquisition unit
110 Input unit
111 Instruction reception unit
112 History storage unit
113 Analysis unit
114 Member detection unit
115 Imaging unit
1000 Computer
1001 Processor
1002 Memory
1003 Storage device
1004 I/O interface
1005 Storage medium
1101 Reading circuit
1102 Work storage device
1103 Projection control circuit
1104 Projection circuit
1105 Object information acquisition circuit
1106 Object identification circuit
1107 Skill level storage device
1108 Worker identification circuit
1109 Worker information acquisition circuit
1110 Input circuit
1111 Instruction reception circuit
1112 History storage device
1113 Analysis circuit
1114 Member detection circuit
1115 Imaging device

1. A work assistance device comprising:
a memory that stores a set of instructions; and
at least one first processor configured to execute the set of instructions to:
read a projection data set for each process, according to a sequence number of the process, from work storage that stores a work procedure in which the projection data set is associated with a sequence number of the process, the projection data set including an indication display including a visually recognizable visual representation indicating, for each process of work performed by a worker, a position where work in a process is performed and a member handled in work in the process; and
project, by a projector, the indication display included in the projection data set, upon readout of the projection data set, for a period of an indication display projection time being a projection time determined for the indication display.

2. The work assistance device according to claim 1, wherein
the projection data set further includes a caution display including the visual representation indicating a caution in the work, and
the at least one first processor is further configured to
project the caution display before projecting the indication display when the read projection data set includes the caution display.

3. The work assistance device according to claim 1, wherein
the projection data set of a second process further includes a guidance display including the visual representation representing guidance from a position where work in a first process is performed to a position where work in the second process is performed, the first process and the second process being two consecutive processes in which a same member is handled, the second process following the first process, and
the at least one first processor is further configured to
project the guidance display when the read projection data set includes the guidance display.

4. The work assistance device according to claim 1, wherein
the visual representation includes a representation by an animation.

5. The work assistance device according to claim 1, wherein
the projection data set further includes the indication display projection time, and
the at least one first processor is further configured to
project the indication display for a period of the indication display projection time included in the read projection data set.

6. The work assistance device according to claim 1, further comprising:
skill level storage that stores a skill level related to the work for each of the worker, wherein
the at least one first processor is further configured to
acquire an identifier of the worker, and
read the skill level of the worker the identifier of whom is acquired, update the indication display projection time based on the read skill level, and project the indication display for a period of the updated indication display projection time.

7. The work assistance device according to claim 1, wherein
the work procedure includes the projection data set of a mounting process being the process of performing work of equipping a part as the member on a substrate, and
the projection data set of the mounting process includes a position on the substrate where the part is equipped, as a position where the work is performed, and includes, as the indication display, a display indicating a location where the part is equipped and a symbol indicating the part.

8. The work assistance device according to claim 7, wherein
the work storage stores the work procedure for each type of the substrate, and
the at least one first processor is further configured to
acquire a type of the substrate; and
read the projection data set included in the work procedure for an acquired type of the substrate.

9. The work assistance device according to claim 1, wherein:
the at least one first processor is further configured to
receive a control instruction being an instruction by the worker for controlling progression of the projection, wherein
store process identification information in history storage when receiving a predetermined type of the control instruction, the process identification information identifying the process in which the indication display is projected when the work indication is performed, and
analyze a frequency of performing the control instruction based on the process identification information stored in the history storage.

10. A work assistance system including the work assistance device according to claim 1, comprising:
the projector.

11. A work assistance method comprising:
successively reading a projection data set for each process, according to a sequence number of the process, from work storage that stores a work procedure in which the projection data set is associated with a sequence number of the process, the projection data set including an indication display including a visually recognizable visual representation indicating, for each process of work performed by a worker, a position where work in a process is performed and a member handled in work in the process; and
projecting, by a projector, the indication display included in the projection data set, upon readout of the projection data set, for a period of an indication display projection time being a projection time determined for the indication display.

12. The work assistance method according to claim 11, wherein
the work procedure includes the projection data set further including a caution display including the visual representation indicating a caution in the work, and
the method comprises projecting the caution display before the indication display is projected when the read projection data set includes the caution display.

13. The work assistance method according to claim 11, wherein
the work procedure includes the projection data set of work in a second process, the projection data set further including a guidance display including the visual representation representing guidance from a position where work in a first process is performed to a position where work in the second process is performed, the first process and the second process being two consecutive processes in which a same member is handled, the second process following the first process, and
the method comprises projecting the guidance display when the read projection data set includes the guidance display.

14. A non-transitory computer readable storage medium storing a work assistance program causing a computer to perform:
reading processing of successively reading a projection data set for each process, according to a sequence number of the process, from work storage that stores a work procedure in which the projection data set is associated with a sequence number of the process, the projection data set including an indication display including a visually recognizable visual representation indicating, for each process of work performed by a worker, a position where work in a process is performed and a member handled in work in the process; and
projection control processing of projecting, by a projector, the indication display included in the projection data set, upon readout of the projection data set, for a period of an indication display projection time being a projection time determined for the indication display.

15. The non-transitory computer readable storage medium according to claim 14, storing the work assistance program, wherein
the work procedure includes the projection data set further including a caution display including the visual representation indicating a caution in the work, and
the projection control processing projects the caution display before projecting the indication display when the read projection data set includes the caution display.

16. The non-transitory computer readable storage medium according to claim 14, storing the work assistance program, wherein
the projection data set of a second process further includes a guidance display including the visual representation representing guidance from a position where work in a first process is performed to a position where work in a second process is performed, the first process and the second process being two consecutive processes in which a same member is handled, the second process following the first process, and
the projection control processing projects the guidance display when the read projection data set includes the guidance display.
